(19) United States
(12) Patent Application Publication
(10) Pub. No.: US 2026/0083044 A1
(43) Pub. Date: Mar. 26, 2026

(54) Seeding System

(71) Applicant: Precision Planting LLC, Tremont, IL (US)

(72) Inventors: Jeremy J. Hodel, Morton, IL (US); Jordan Charles Solberg, East Peoria, IL (US)

(21) Appl. No.: 19/103,400

(22) PCT Filed: Sep. 4, 2023
(86) PCT No.: PCT/IB2023/058740

§ 371 Date: Feb. 12, 2025

Related U.S. Application Data
(60) Provisional application No. 63/375,139, filed on Sep. 9, 2022.
(60) Provisional application No. 63/375,143, filed on Sep. 9, 2022.
(60) Provisional application No. 63/385,568, filed on Nov. 30, 2022.
(60) Provisional application No. 63/434,649, filed on Dec. 22, 2022.
(60) Provisional application No. 63/434,659, filed on Dec. 22, 2022.
(60) Provisional application No. 63/434,667, filed on Dec. 22, 2022.
(60) Provisional application No. 63/434,671, filed on Dec. 22, 2022.
(60) Provisional application No. 63/501,172, filed on May 10, 2023.
(60) Provisional application No. 63/504,352, filed on May 25, 2023.

(51) Int. Cl. A01C 7/04; A01C 7/08

(52) U.S. Cl. CPC A01C 7/046; A01C 7/082

(57) ABSTRACT

A seed firming wheel assembly (600) with resilient suspension for a planting row unit (100) includes a mounting bracket (610), torsion axle (650), and suspension arm (630). The mounting bracket (610) comprises a first end (611) configured to be coupled to a frame (110) of the row unit (100) and a second end (612) to which the torsion axle (650) is coupled. The suspension arm (630) includes an upper end detachably coupled to the torsion axle (650) and a lower end to which a firming wheel rotatably coupled. The firming wheel is supported in a cantilevered manner from the torsion axle (650) by the suspension arm (630). The firming wheel is operable to press seeds into soil within a planting trench as the seed are deposited by the row unit. The second end (612) of the mounting bracket (610) may be free floating. The torsion axle (650) dampens motion of the firming wheel as the row unit (100) travels the agricultural field.

### CROSS REFERENCE TO RELATED APPLICATIONS

This application claims priority to U.S. Application No. 63/375139, filed on 2022 Sep. 9; U.S. application Ser. No. 63/375143, filed on 2022 Sep. 9; U.S. Application No. 63/385568, filed on 2022 Nov. 30; U.S. Application No. 63/434649, filed on 2022 Dec. 22; U.S. Application No. 63/434659, filed on 2022 Dec. 22; U.S. Application No. 63/434667, filed on 2022 Dec. 22; U.S. Application No. 63/434671, filed on 2022 Dec. 22; U.S. Application No. 63/501172, filed on 2023 May 10; U.S. Application No. 63/504352, filed on 2023 May 25, all of which are incorporated herein by reference in their entireties.

### FIELD

Embodiments of the present disclosure relate generally to seed delivery systems used in conjunction with planting crops.

### BACKGROUND

Crop yields are affected by a variety of factors, such as seed placement, soil quality, weather, irrigation, and nutrient applications. Seeds are typically planted in trenches formed by discs or other mechanisms of a planter row unit. Depth of seed placement is important because seeds planted at different depths emerge at different times, resulting in uneven crop growth. Spacing of seeds can affect yield because plants that are too close together compete for nutrients, and plants too far apart leave wasted space between them.

Agricultural row crop planters typically include a seed hopper connected to a seed metering system that delivers seeds into a furrow formed by disc opener blades. A plurality of these row crop planters are typically mounted in parallel along a tool bar which is attached to a powered vehicle such as a tractor which traverses the agricultural field. For example, it is common to have four, sixteen, twenty-four, thirty-six, or even forty-eight row units attached to a single tractor.

Within a typical prior art row crop planter, seeds are delivered in bulk from the seed hopper to the metering system. The metering system singulates the bulk seeds and will most preferably provide these singulated seeds at very predictable and repeatable time intervals. The row crop planter subsequently delivers one seed at a time into the ground, typically into a furrow cut by the opener blades.

One common prior art method of seed delivery from the seed hopper to the ground is a gravity drop system that locates a seed dispensing tube inlet below the seed metering system. A singulated seed drops from the metering system down the seed dispensing tube and into a furrow prepared by opener blades disposed forward of the seed dispensing tube.

Improvements are desired in approaches for transferring and accelerating seed from the seed meter to the seed dispensing tube for planting.

### BRIEF SUMMARY

The present disclosure provides various embodiments of a seed delivery system each configured to transfer and accelerate seed dispensing from a rotatable metering disc of a seed meter to a seed dispensing tube from which the seeds are implanted in succession in the planting trench. Some embodiments of an air-operated seed accelerator described herein are configured and designed to capture and dispense seeds from the seed meter by entraining the seeds in a pressurized airstream. Another embodiment of a mechanically-operated seed accelerator described herein is configured and designed to mechanically dispense seeds from the seed meter via physical dislodgement from the seed meter.

A first air-operated seed accelerator is configured to convey the airstream through an air entrainment chamber of a seed capture shroud from an inward to an outward and downward direction across the metering disc to capture the seeds from the seed holes.

A second air-operated seed accelerator is configured to convey the airstream through the air entrainment chamber of the seed capture shroud from an outward to an inward and downward direction across the metering disc to capture the seeds from the seed holes.

An embodiment of a mechanically-operated seed accelerator includes a rotatable accelerator wheel to physically dislodge and dispense seeds from the metering disc of the seed meter to the seed dispensing tube. The accelerator wheel may be used in conjunction with an associated seed guide wall of the accelerator which both guides and accelerates the dispensed seed to the seed dispensing tube. The wheel may comprise a plurality of radial fingers which frictionally engage and compress the seeds against the guide wall for controlled dispensing of the seeds.

The metering disc of the seed meter may be configured to singulate seed received from a seed hopper and provide the seeds to the seed dispensing tube in a preselected orientation.

The seed dispensing tube may have a generally cylindrical interior, and in some embodiments at least a portion of the tube may comprise helical seed orientation surfaces which engage and manipulate the seeds to provide a predetermined seed orientation for planting in the planting trench.

Other technical features may be readily apparent to one skilled in the art from the following figures, descriptions, and claims.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example (“exemplary”) embodiments when read in conjunction with the accompanying drawings, in which the features of the exemplary embodiments will be described with reference to the following drawings where like elements are labeled similarly, and in which:

FIG. 1 is a perspective view of a crop planter row unit including a seed delivery system according to the present disclosure;

FIG. 2 is an enlarged detail view thereof with one of the guide wheels removed;

FIG. 3 is a side view of the row unit;

FIG. 4 is a top perspective view of a portion of the row unit with a seed delivery system according to the present disclosure;

FIG. 5 is a bottom perspective view thereof;

FIG. 6 is a rear view thereof;

FIG. 7 is a front view thereof;

FIG. 8 is a left side view thereof relative to the direction of travel of the row unit;

FIG. 9 is a right side view thereof;

FIG. 10 is a top view thereof;

FIG. 11 is a bottom view thereof;

FIG. 12 is a rear perspective view thereof with seed hopper removed;

FIG. 13 is a front perspective view thereof with seed hopper removed;

FIG. 14 is a first exploded perspective view thereof;

FIG. 15 is a second exploded perspective view thereof;

FIG. 16 is a perspective view of a portion of the row unit with a first embodiment of an air-operated seed accelerator according to the present disclosure;

FIG. 17 is an enlarged detail of the seed accelerator in FIG. 16;

FIG. 18 is an enlarged detail view showing a seed capture shroud of the seed accelerator in FIG. 17 and a portion of the seed metering disc of the seed meter showing seed holes of the disc entering the shroud;

FIG. 19 is a first perspective view of the air-operated seed accelerator of FIG. 16;

FIG. 20 is a second perspective view thereof;

FIG. 21 is a third perspective view thereof;

FIG. 22 is a side view of the seed meter with seed metering disc and seed dispensing tube with the first embodiment of the seed accelerator shown in phantom dashed lines;

FIG. 23 is side cross sectional view of a portion of the metering disc showing the first embodiment of the seed accelerator in FIG. 22;

FIG. 24 is a perspective view of a portion of the row unit with a second embodiment of an air-operated seed accelerator according to the present disclosure;

FIG. 25 is an exploded perspective view thereof;

FIG. 26 is an enlarged detail taken from FIG. 25 showing the sub-trench opener which is common to all embodiments of the row unit disclosed herein;

FIG. 27 is an enlarged detail view showing a seed capture shroud of the second embodiment of the seed accelerator in FIG. 24 and a portion of the seed metering disc of the seed meter showing seed holes of the disc entering the shroud;

FIG. 28 is a first perspective view of the air-operated seed accelerator of FIG. 16;

FIG. 29 is a second perspective view thereof;

FIG. 30 is a third perspective view thereof;

FIG. 31 is a side view of the seed meter with seed metering disc and seed dispensing tube with the second embodiment of the seed accelerator shown in phantom dashed lines;

FIG. 32 is side cross sectional view of a portion of the metering disc showing the second embodiment of the seed accelerator in FIG. 31;

FIG. 33 is an exploded perspective view of a portion of the row unit with an embodiment of a wheeled mechanical seed accelerator according to the present disclosure;

FIG. 34 is an assembled perspective view thereof;

FIG. 35 is an enlarged detail view showing the mechanical seed accelerator in FIG. 34 and a portion of the seed metering disc of the seed meter showing the accelerator wheel and guide wall of the seed chute;

FIG. 36 is a first perspective view of the mechanical seed accelerator of FIG. 35;

FIG. 37 is a second perspective view thereof;

FIG. 38 is a side view of the seed meter with seed metering disc with the mechanical seed accelerator of FIGS. 36-37 shown in phantom dashed lines;

FIG. 39 is a side view thereof showing a cross-sectional view of the mechanical seed accelerator of FIG. 38 in solid lines relative to the metering disc;

FIG. 40 is an enlarged detail from FIG. 39 showing the accelerator wheel of guide wall with seed guide surface of the seed chute;

FIG. 41 is a side elevation view from FIG. 8 with notched opener discs;

FIG. 42 is a perspective view of a notched opener disc;

FIG. 43 is a side elevation view of the notched opener disc of FIG. 42;

FIG. 44 is a front elevation view of the notched opener disc of FIG. 42;

FIG. 45 is a rear elevation view of the notched opener disc of FIG. 42;

FIG. 46 is a rear perspective view of the seed dispensing tube comprising an optional air deflection baffle;

FIG. 47 is an enlarged view from FIG. 46;

FIG. 48 is a front perspective view of the air deflection baffle;

FIG. 49 is an enlarged view from FIG. 48;

FIG. 50 is an enlarged side perspective view of the bottom end of the seed dispensing tube with air deflection baffle;

FIG. 51 is an enlarged rear perspective view thereof;

FIG. 52 is a side view of a first embodiment of the air deflection baffle;

FIG. 53 is a side view of a second embodiment of the air deflection baffle;

FIG. 54 is a side view of planting row unit which shows the position of the air deflection baffle relative to the row unit components;

FIG. 55 is an enlarged perspective view of a bottom portion of the seed dispensing tube showing a stabilizing block thereon coupled to an optional sub-trench opener of the planting row unit;

FIG. 56 is an exploded perspective view thereof;

FIG. 57 is a side view of a planting row unit with seed firming wheel assembly and resilient suspension system according to the present disclosure;

FIG. 58 is a first perspective view thereof;

FIG. 59 is a second perspective view thereof;

FIG. 60 is a left side perspective view thereof;

FIG. 61 is a right side perspective view thereof;

FIG. 62 is a rear view thereof;

FIG. 63 is a bottom view thereof;

FIG. 64 is a top left perspective view thereof with portions of the row unit frame and gauge wheels removed to reveal the seed firming wheel assembly;

FIG. 65 is a top right perspective view thereof;

FIG. 66 is a right perspective view of the seed firming wheel assembly in isolation;

FIG. 67 is a left perspective view thereof;

FIG. 68 is a right exploded perspective view thereof;

FIG. 69 is a left exploded perspective view thereof;

FIG. 70 is left side view thereof;

FIG. 71 is a right side view thereof;

FIG. 72 is a rear view thereof with the torsion axle shown in cross-sectional taken along the lines appearing in FIG. 70;

FIG. 73 is a perspective view of part of the firming wheel assembly showing the internal features of the torsion axle; and

FIG. 74 is an enlarged detail of the firming wheel assembly mounting bracket to row unit frame interface.

All drawings are schematic and not necessarily to scale. Parts shown and/or given a reference numerical designation in one figure may be considered to be the same parts where they appear in other figures without a numerical designation for brevity unless specifically labeled with a different part number and described herein. A reference herein to a figure by number but which includes multiple figures sharing the same number with different alphabetical suffixes shall be considered as a reference to all of those figures unless noted otherwise.

### DETAILED DESCRIPTION

All references to other applications cited herein are incorporated herein by reference in their entireties. If there is a conflict between a definition herein and in an incorporated reference, the definition herein shall control.

The illustrations presented herein are not actual views of any planter row unit or portion thereof, but are merely idealized representations to describe example embodiments of the present disclosure. Additionally, elements common between figures may retain the same numerical designation.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of”and “consisting essentially of”and grammatical equivalents thereof.

As used herein, the term “may” a recited herein with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, orientation, arrangement, and other physical attributes of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used herein, the term “about” used in reference to a given parameter is inclusive of the stated value and has the meaning dictated by the context (e.g., it includes the degree of error associated with measurement of the given parameter or manufacturing tolerances).

As used throughout, ranges are used as shorthand for describing each and every value that is within the range. Any value within the range can be selected as the terminus of the range.

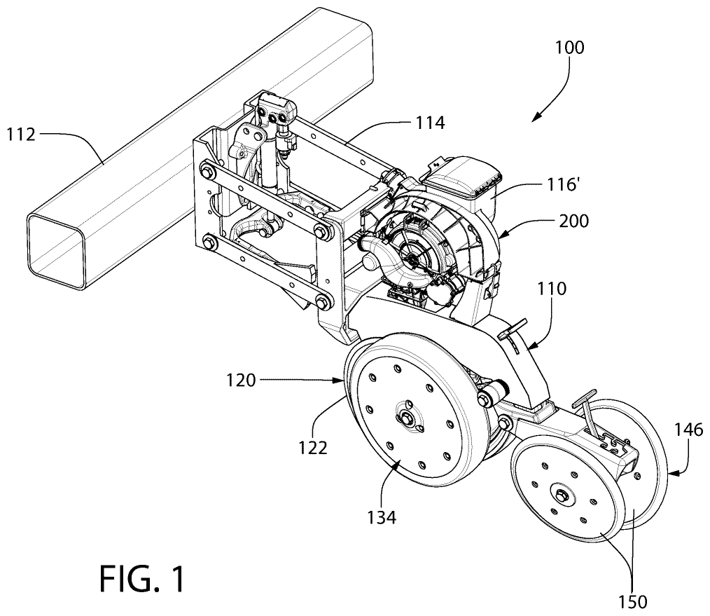

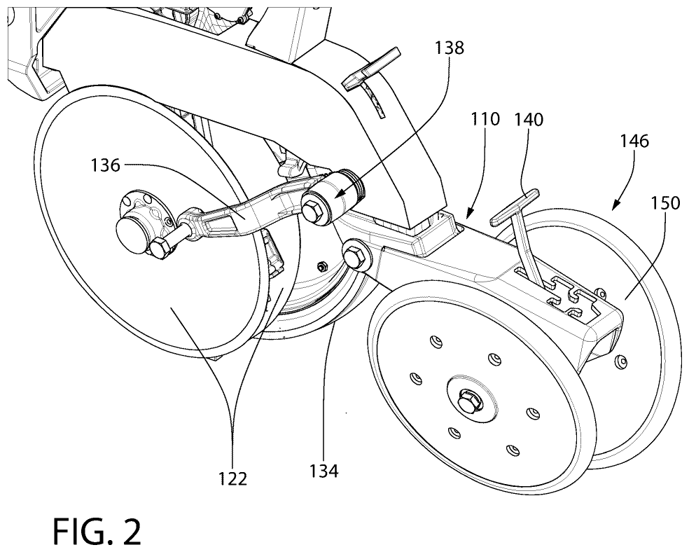

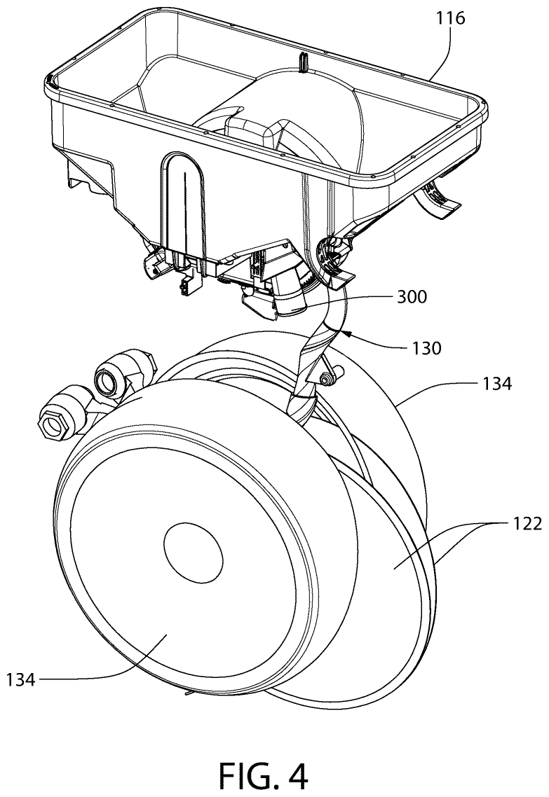

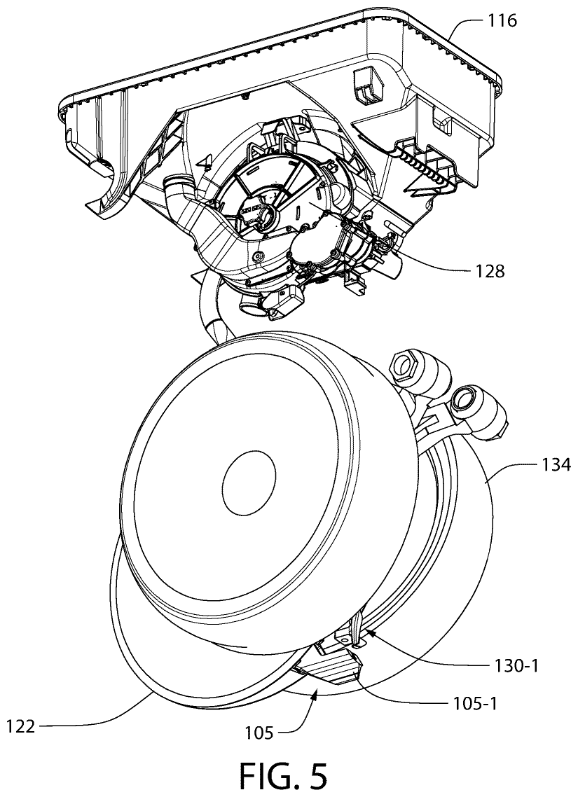

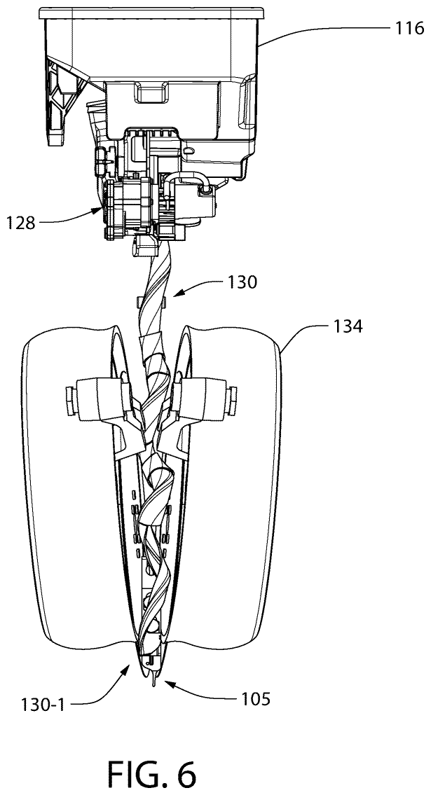

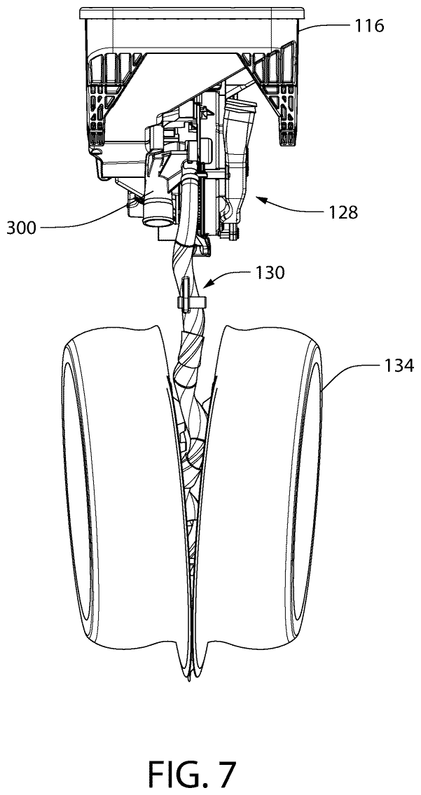

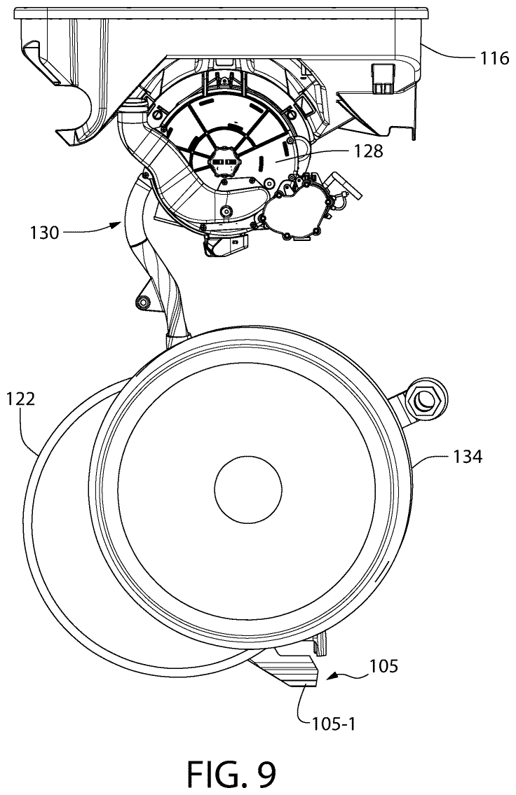

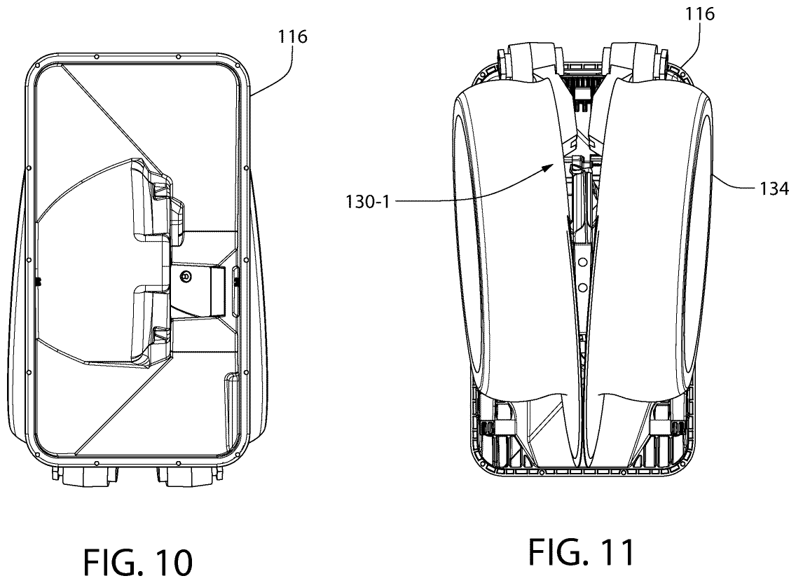

FIGS. 1-3 illustrate an embodiment of an agricultural planter row unit 100. The row unit 100 has a support frame 110 pivotally connected to a toolbar 112 by a movable linkage arm assembly 114, enabling each row unit 100 to move vertically independently of the toolbar 112 and of other row units 100 as the row unit traverses the agricultural field. The frame 110 operably supports one or more seed hoppers 116 of any suitable type and configuration which hold seeds for planting, a seed trench opening assembly 120, a seed delivery system 200 which draws seeds from the hopper and dispenses the seed to the planting trough, and a seed trench closing assembly 146. The row unit 100 shown may also be used with a conventional planter row unit each having a single individual large capacity seed hopper 116 which is individually filled with seeds (see, e.g., FIGS. 4-11).

Alternatively, the row unit of FIGS. 1-3 may be used with a central fill planter, in which latter case the large capacity hoppers 116 previously described herein may be replaced with one or more mini-hoppers 116′mounted to each row unit as shown. The mini-hoppers are fluidly coupled to a large central hopper via fill tubes (not shown) which in turn distributes the seeds to all row units. Such central fill planters are well known in the art without further elaboration necessary.

It bears noting that the support frame 110 is used to collectively designate an assemblage of various structural members (e.g., beams, angles, straps, braces, rods, brackets, and other components) which are coupled together and cooperate to structurally support some or all of the components and devices of the row unit 100 and seed delivery system 200 described herein. Any suitable types and number of structural members may be provides in any suitable configuration for this purpose.

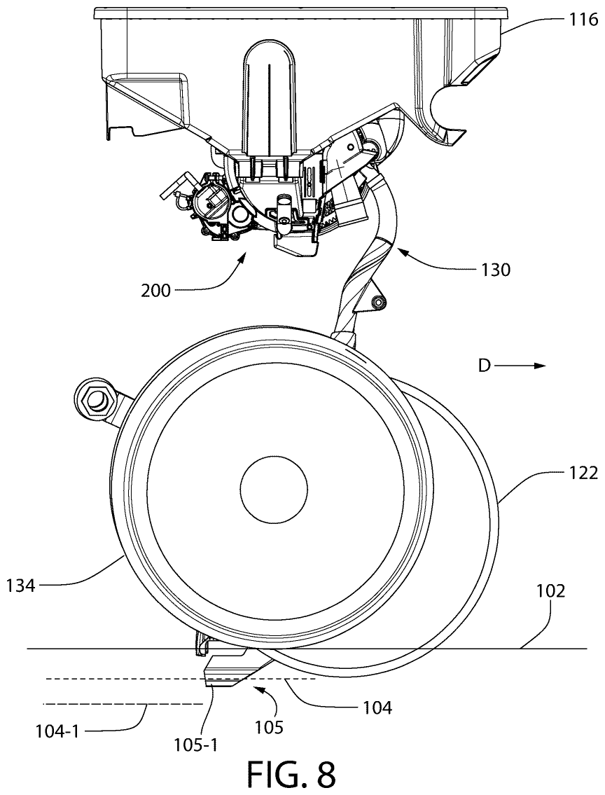

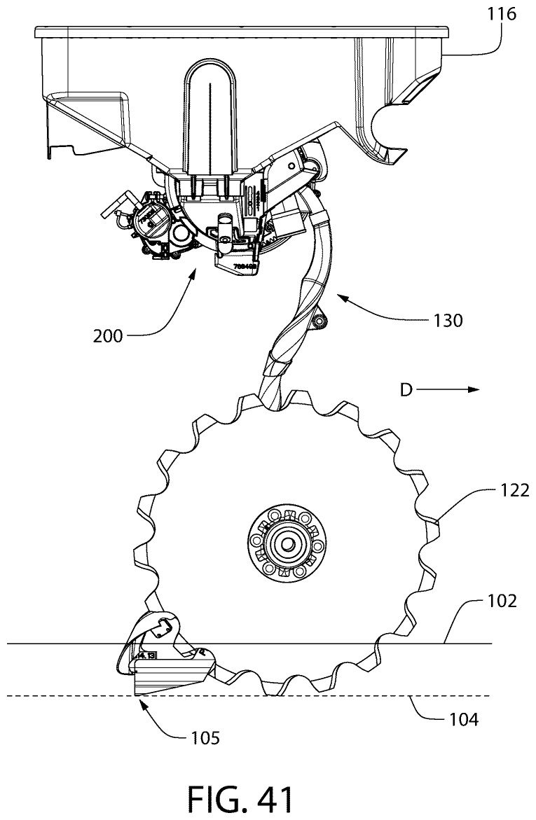

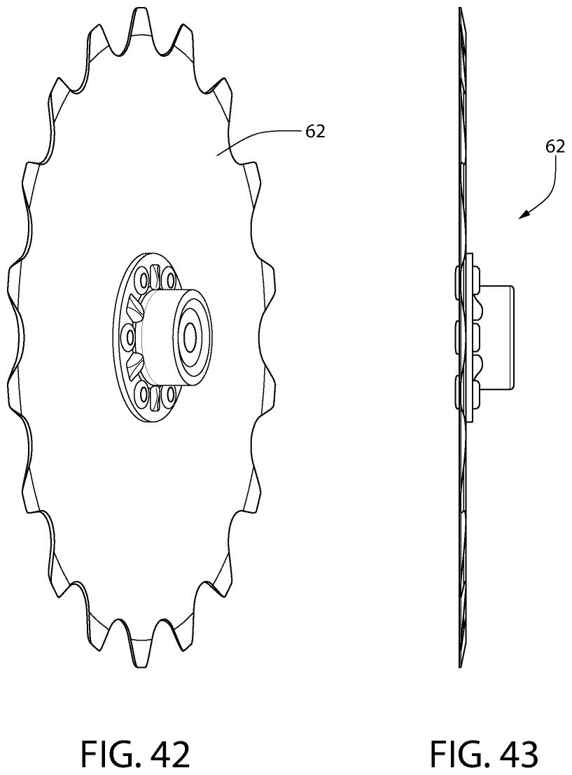

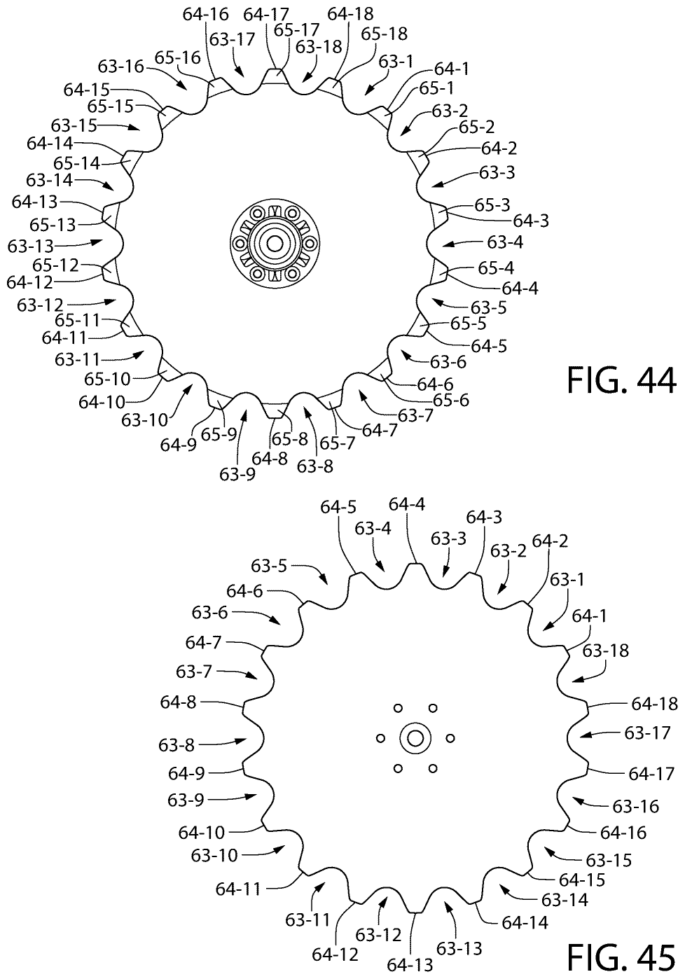

Referring to FIGS. 1-11 in general as applicable, the seed trench opening assembly 120 includes a pair of opening discs 122 rotatably supported by the frame 110. The opening discs 122 are arranged to diverge outwardly and rearwardly so as to open a V-shaped seed furrow or trench 104 in the soil 102 (see, e.g., FIG. 8) as the planter traverses the field in a forward direction of travel D. In other embodiments, a seed-trench opening assembly is described in U.S. Ser. No. 63/262415, filed 12 Oct. 2021, and U.S. Ser. No. 63/262417, filed 12 Oct. 2021 may be used. In some embodiments, notched discs can be used as opening discs 122. Examples of notched discs are disclosed in U.S. Application No. 63/385568, filed 30 Nov. 2022. FIGS. 8-11 from 63/385568, reproduced here as FIGS. 42-45, illustrate the notched opener disc 62. Notched opener disc 62 has a plurality of notches 63 (63-1 to 63-18). While illustrated with 18 notches, notches opener disc 62 can have any number of notches 63. Between successive notches 63 is a tooth 64. As illustrated, there are 18 teeth 64 (64-1 to 64-18). Optionally, tooth 64 can have a taper 65 (65-1 to 65-18). While illustrated with taper 65 on one side of tooth 64, both sides of tooth 64 can have a taper 65. When there is one taper 65, notched opener disc 62 can be oriented on row unit 14 such that taper 65 is disposed on notched opener disc 62 on a side away from row unit 14. While illustrated as flat, notched opener disc 62 can be concave. FIG. 41 illustrates notched opener discs 62 in the embodiment from FIG. 8.

In some embodiments, a sub-trench opener 105 can optionally be included. Sub-trench opener 105 is coupled to row unit 100 such as to an available portion of frame 110 by mounting bracket 105-3 (see, e.g., FIGS. 25-26 and 55). Sub-trench opener 105 is disposed rearward from opening disc assembly 60 in the trench opened by seed trench opening assembly 120. The sub-trench opener 105 can optionally comprise a blade 105-1 which extends below opening discs 112 to create an optional sub-trench 104-1 in the soil at the bottom of and within planting trench 104. This creates a more smaller V-shaped compact trench profile within the larger outer trench 104 so that seeds deposited into the sub-trench are constrained from moving laterally or forwardly/rearwardly in the soil to maintain their preferred orientation and position in the trench. Seed dispensing tube 130 can be arranged and positioned to deposit seeds into the sub-trench via the tube discharge opening 130-1 at bottom behind and following the sub-trench opener 105 relative to the direction of travel D of the row unit 100 through the agricultural field.

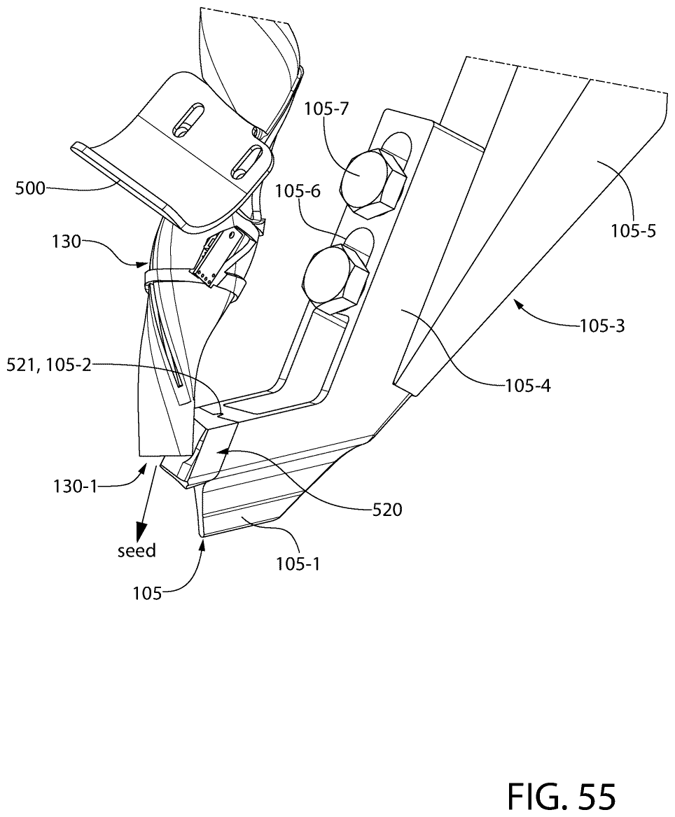

Mounting Bracket 105-3 of sub-trench opener 105 may include a fixed portion 105-5 configured for rigid coupling to row unit frame 110 and an adjustable portion 105-4 movably coupled to the fixed portion. This allows the depth of the sub-trench formed at the bottom of planting trench 104 to be adjusted. To provide the adjustability, the adjustable portion 105-4 of bracket 105-3 may include a pair of slots 105-6 which receive threaded fasteners 105-7 which engage the fixed portion 105-5 (see, e.g., FIG. 55).

When notched opener disc 62 and sub-trench opener 105 are combined, notched opener disc 62 can create a general and larger outer furrow in which sub-trench opener 105 can create a smaller sub-trench without sub-trench opener 105 having to perform all of the work, which would lead to more wear on sub-trench opener 105 particularly when encounter crop residue or rocks/stones which may be in the agricultural field.

The seed delivery system 200 includes a seed meter 128, a seed dispensing tube 130, and a first embodiment of a seed accelerator 300, and that together cooperate to deliver seeds at a preselected rate from seed hoppers 116 or 116′to the soil. Seeds are communicated and transferred from the hopper to seed meter 128 which is configured to singulate the supplied seeds. In one embodiment, seed meter 128 may be a vacuum-type meter such as that disclosed in Applicant's International Patent Publication No. WO/2012/129442 or U.S. Patent Application Publication 2019/0230846, or any commercially available vacuum-type seed meter such as without limitation the VSet® meter, available from Precision Planting LLC, 23333 Townline Rd, Tremont, Ill. 61568.

In operation, the seed meter 128 preferably deposits the supplied seeds into the seed dispensing tube 130 via the seed accelerator 300, which in turn delivers the seed to the planting trench 104. The seed dispensing tube 130 may be removably mounted to a portion or portions of the frame 110.

Seeds dispensed by the seed accelerator 300 from seed meter 128 are directed into and through the seed dispensing tube 130 into the planting trench 104. The seed meter 128 may be configured to receive seeds from the seed hopper 116 or 116′, and orient seeds in a preselected orientation to the seed dispensing tube 130 by any selected method, such as that shown and described in U.S. Patent Application Publication 2019/0230846, “Systems, Implements, and Methods for Seed Orientation with Adjustable Singulators During Planting,” published Aug. 1, 2019.

The discharge opening 130-1 at the bottom end of seed dispensing tube 130 is positioned between the opening discs 122 to deliver seed from the seed meter 128 into the opened seed trench 104. The depth of the seed trench 104 is controlled by a pair of gauge wheels 134 positioned adjacent to the opening discs 122. The gauge wheels 134 are rotatably supported by gauge wheel arms 136, which are pivotally secured at one end to the frame 110 about pivot pin 138. An adjustment handle 140 supported by the frame 110 is operably coupled to arms 136 and configured to form a gauge wheel adjustment mechanism. The handle is moveable fore and aft to raise or lower the gauge wheels 134 relative to the frame and opening discs 122. This allows adjustment of and sets the depth of the seed trench 104 by limiting the upward travel of the gauge wheel arms 136 (and thus the gauge wheels 134) relative to the opening discs 122. Accordingly, the depth of cut produced by opening discs 122 is controlled by the gauge wheel adjustment mechanism.

The seed trench closing assembly 146 includes a pair of offset closing wheels 150 which are rotatably coupled to frame 110. Wheels 150 are angularly disposed relative to each other to “close” the seed trench 104 by pushing the walls of the open seed trench back together over the deposited seed 106 as the row unit 100 passes by. The seed trench closing assembly 146 in some embodiments may be of the type disclosed in U.S. Pat. No. 9,848,524, “Agricultural Seed Trench Closing Systems, Methods, and Apparatus,”granted Dec. 26, 2017.

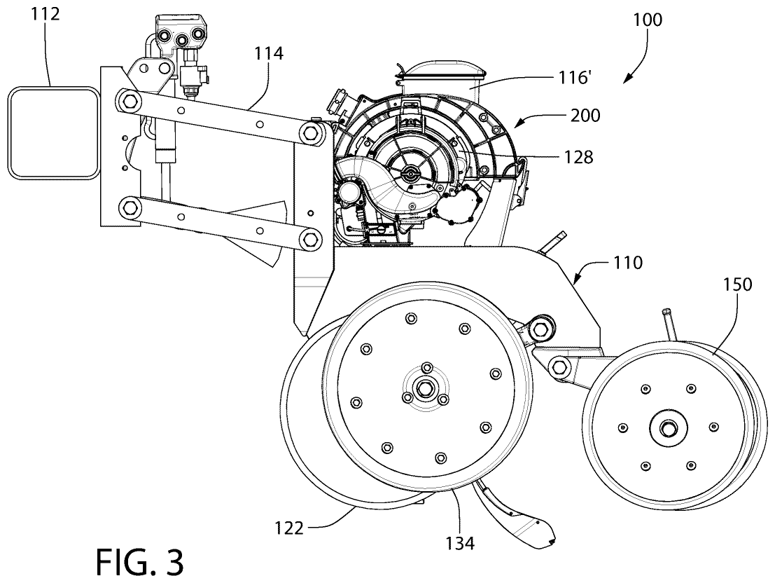

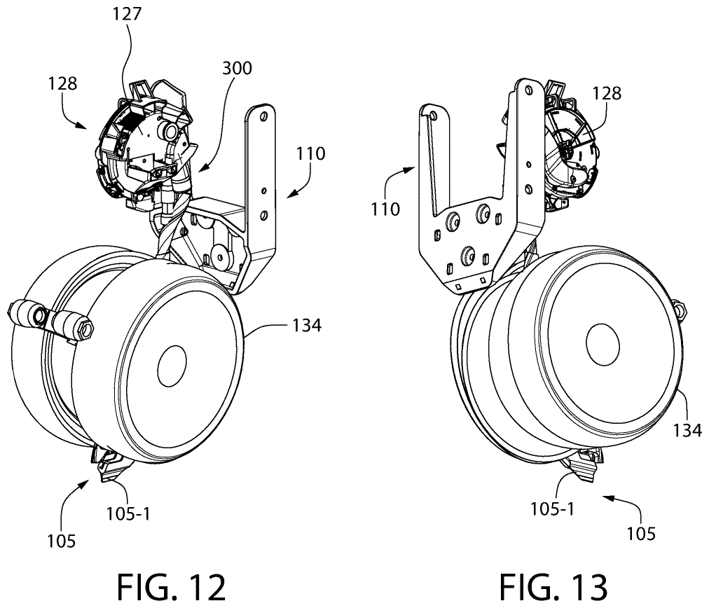

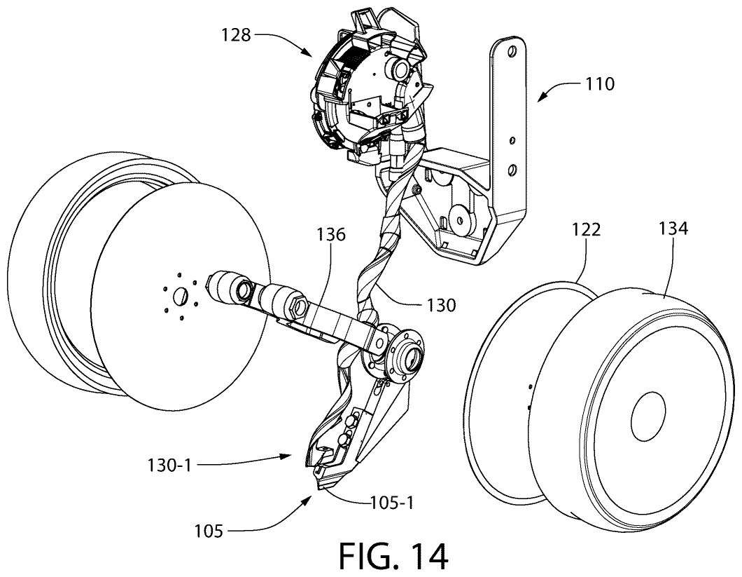

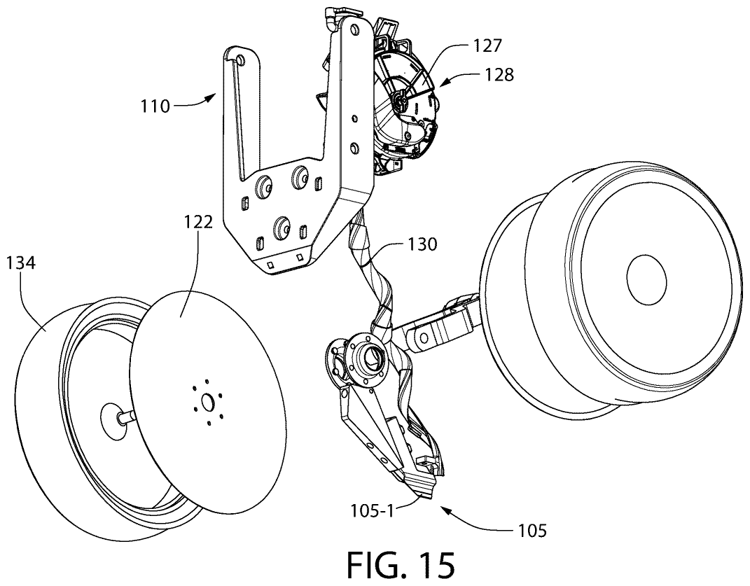

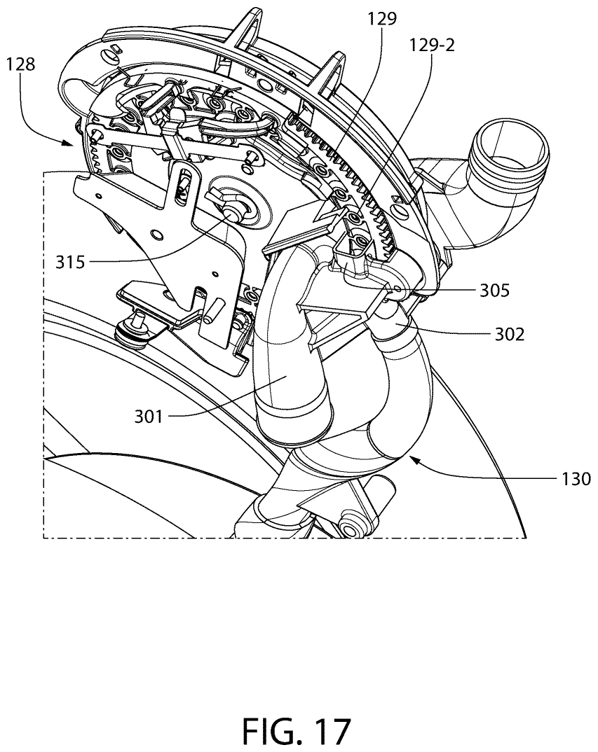

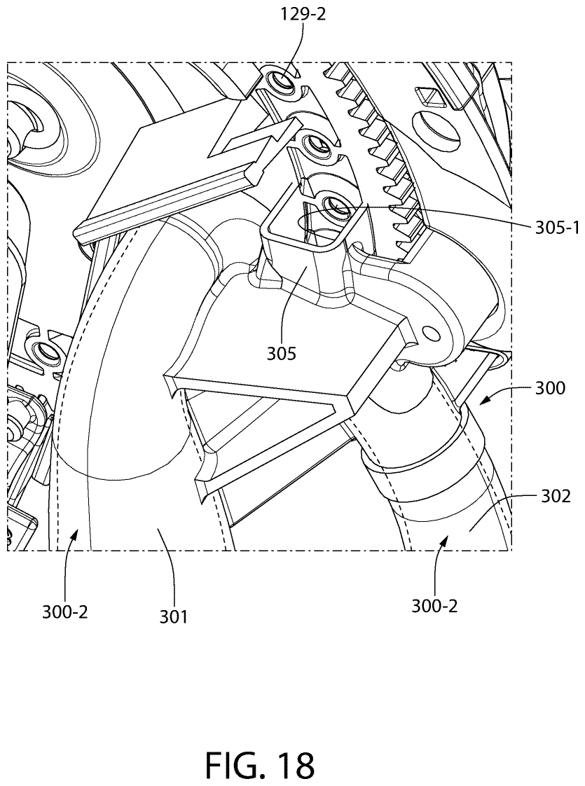

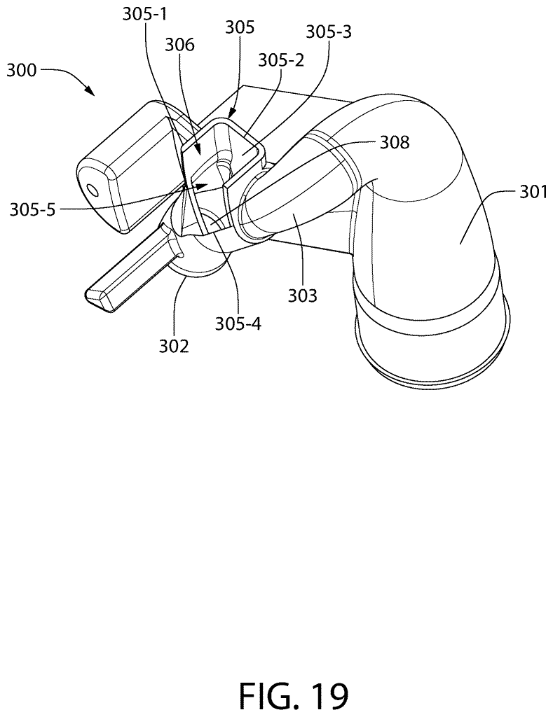

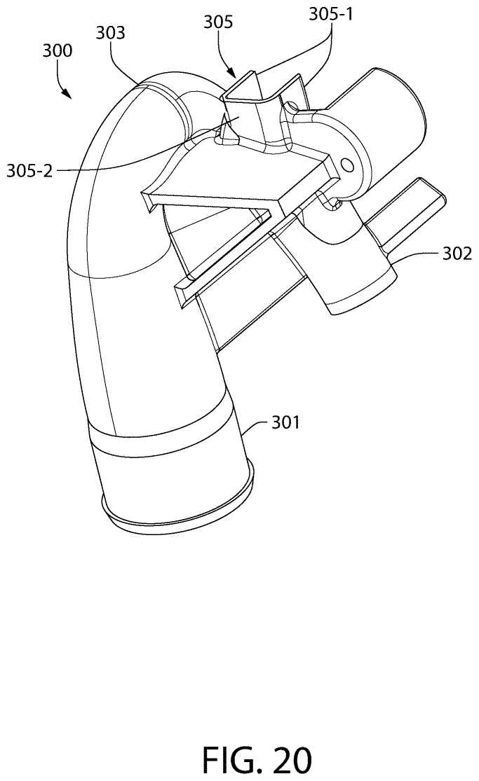

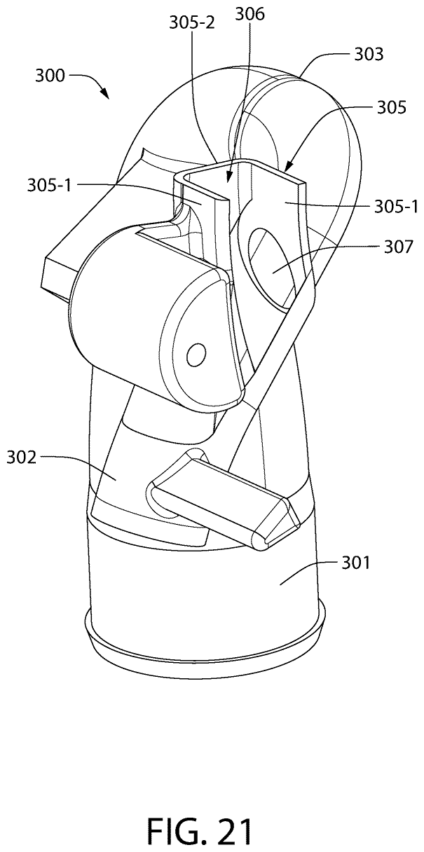

Aspects and components of the seed delivery system 200 will now be further described with general reference to FIGS. 3-16, and in particular to FIGS. 17-23 which show greater details of the seed delivery system components.

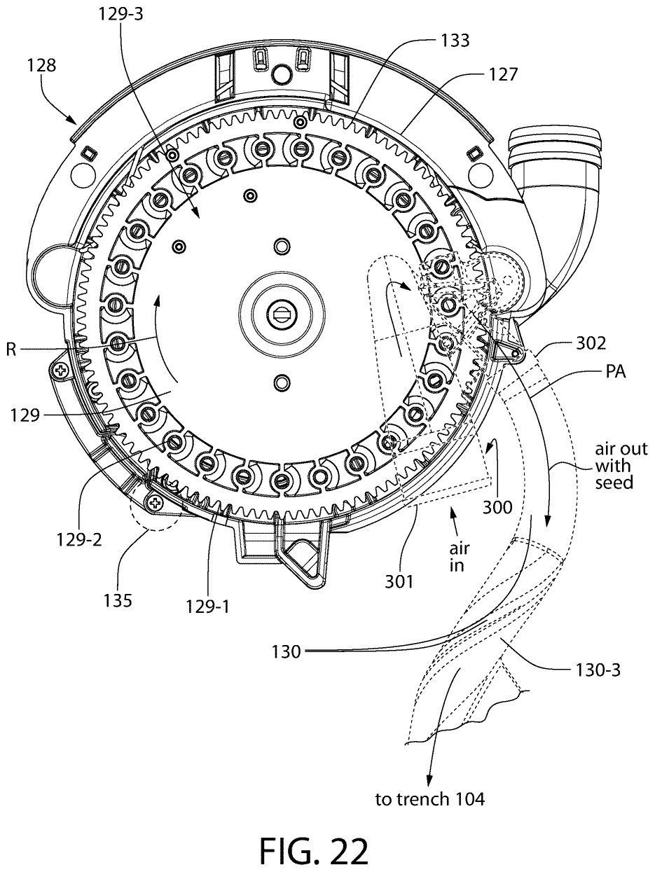

Seed meter 128 comprises a circular outer housing 127 and internal seed metering disc 129 which rotates within the seed meter and receives seed from hopper 116. Disc 129 is rotatably mounted to shaft 315 located at the geometric center of the disc and seed meter 128 which defines a rotational axis RA1 of the disc. Disc 129 rotates in a rotational direction R designated by the rotational arrow shown (e.g., clockwise in FIG. 22). A compatible electric motor drive 135 (represented schematically in FIG. 22) such as a geared motor drive like vDrive commercially-available from Precision Planting LLC, Tremont, Illinois may be used to rotate metering disc 129 at the desired rotational speed. The circumferential peripheral edge 129-1 of the metering disc comprises driven gear teeth 133 which are engaged by mating gear drive teeth of the motor drive to rotate the disc. Other suitable metering disc drive mechanisms may be used.

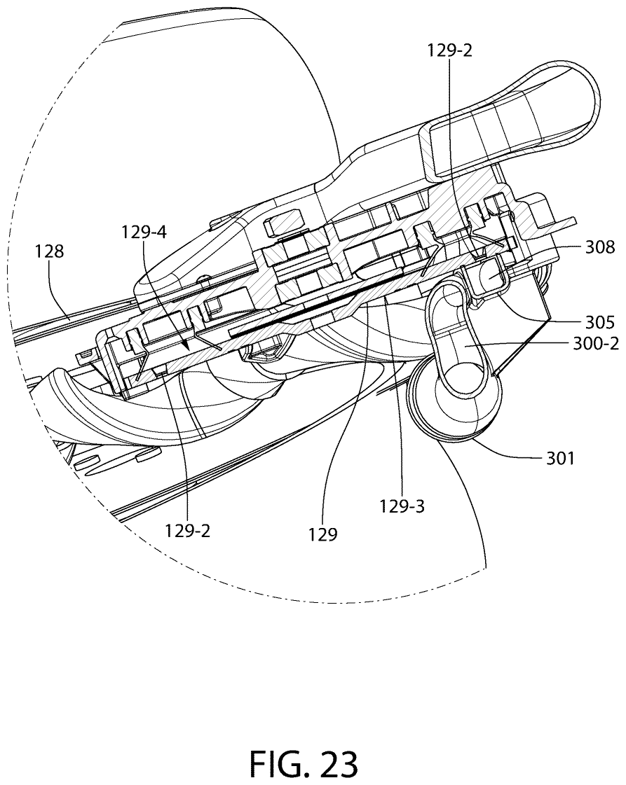

The seed metering disc 129 metering disc includes a circular array of seed holes 129-2 each configured to retain a seed. Seed holes 129-2 are spaced peripherally about a perimeter region of the disc. The seed holes extend completely through metering disc 129 between and through two opposing major surfaces 129-3, 129-4 of the disc (see, e.g., FIG. 23). Holes 129-2 may be radially spaced slightly inward from the circumferential edge 129-1 of disc 129 in one embodiment as shown. Seed holes 129-2 define a circular seed path of travel P of the seeds as the metering disc rotates in rotational direction R. The seed holes 129-2 are circumferentially spaced apart and define pockets in which a single seed is captured from seeds inside seed meter 128 which are drawn from the hoppers 116 or 116′. A vacuum drawn on the seed holes 129-2 from major surface 129-4 of the metering disc 129 by a provided commercially-available vacuum system (not shown) used with the vacuum type seed meter like a vDrive® from Precision Planting LLC, Tremont, Illinois attracts and retains a seed in each seed hole on the opposite major surface 129-3 of metering disc 120. The seed metering disc 129 may be oriented vertically when in use and the vacuum may be terminated in one sector of the circular disc (e.g., 3-6 o'clock position) to release the seeds from the seed holes 129-2.

As known in the art, the size and spacing of the seed holes 129-2 may be varied and customized based on the specific type of seed to be planted. As the metering disc 129 rotates, the seed meter 128 singulates and delivers one seed at a time dispensed from hopper 116 or 116′ to seed dispensing tube 130 via seed accelerometer 300, as further described herein. Accordingly, a variety of interchangeable custom metering discs 129 are provided which can be selected for the specific type of seed being planted. The metering discs are removably mountable in seed meter 129 for that purpose.

Either or each of the seed meter 128, seed accelerator 300, and seed dispensing tube 130 may be configured to orient seeds in a preselected orientation to the seed dispensing tube 130 by any selected method. In some embodiments, seed meter 128 may be configured to orient seeds before or as they are delivered to seed dispensing tube 130 via seed accelerator 300. For example, seed meter 128 may include a vision system and a singulator with features (e.g., lobes) configured to orient seeds, such as shown in FIGS. 4A-4C of commonly-owned U.S. Patent Application Publication 2019/0230846, “Systems, Implements, and Methods for Seed Orientation with Adjustable Singulators During Planting,” published Aug. 1, 2019. In some embodiments, a separate seed orientation system is provided either adjacent the inlet to seed dispensing tube 130, intermediate along seed dispensing tube 130, or adjacent the outlet of seed dispensing tube 130. Suitable exemplary seed orientation apparatuses and systems are shown and described in U.S. Patent Application Publications 2020/0367425, entitled “Seed Orientation System for Agricultural Planters” and published Nov. 26, 2020, and 2022/0192079, entitled “Aerodynamic and Centrifugal Seed Orientation System for Agricultural Planters” and published Jun. 23, 2022. In alternative embodiments other types of seed orientation systems are used, including but not solely limited to those described in the background section herein above.

In some embodiments, seed dispensing tube 130 may be generally cylindrical in configuration with a tubular body including a generally cylindrical interior. In other embodiments, the seed dispensing tube 130 may have another shape, for example without limitation a tapered body with gradually reducing moving downwards towards the discharge end of the seed dispensing tube at the bottom (seed exit), or a non-cylindrical geometry.

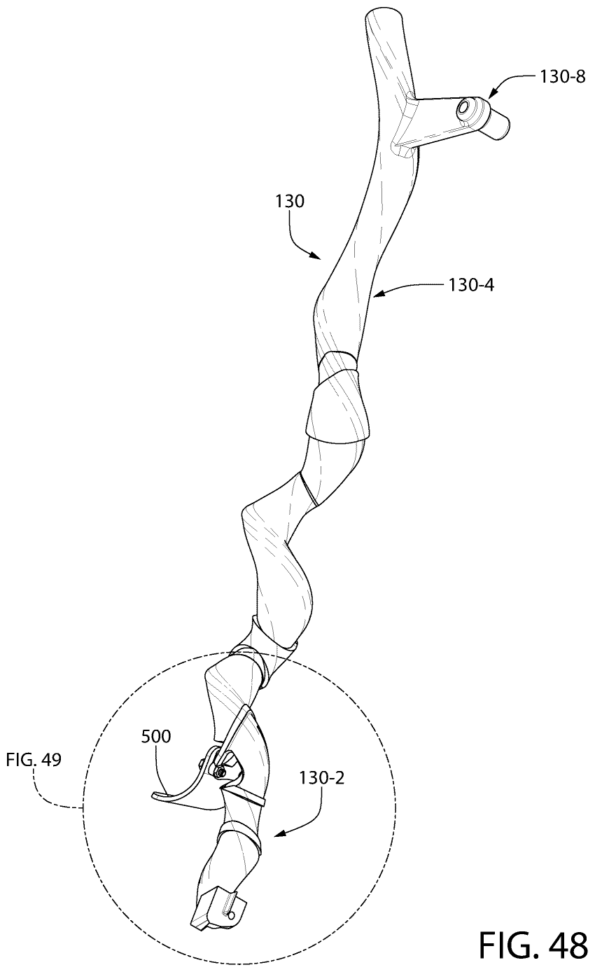

In the illustrated embodiment, at least a portion of seed dispensing tube 130 may have a helical configuration defining curved and twisting helical seed orientation surfaces 130-3 which engage and manipulate the seeds to provided a predetermined seed orientation for planting in the planting trench (see, e.g., FIGS. 22 and 25-26). FIG. 22 shows a seed dispensing tube 130 combining a plain tubular upper portion coupled to air outlet tube 302 of seed accelerator 300 and a lower helical portion which includes internal helical seed orientation surfaces 130-3. The upper portion of dispensing tube 130 may include a mounting protrusion 130-8 (see, e.g., FIG. 48) configured to couple and support the tube from the row unit frame.

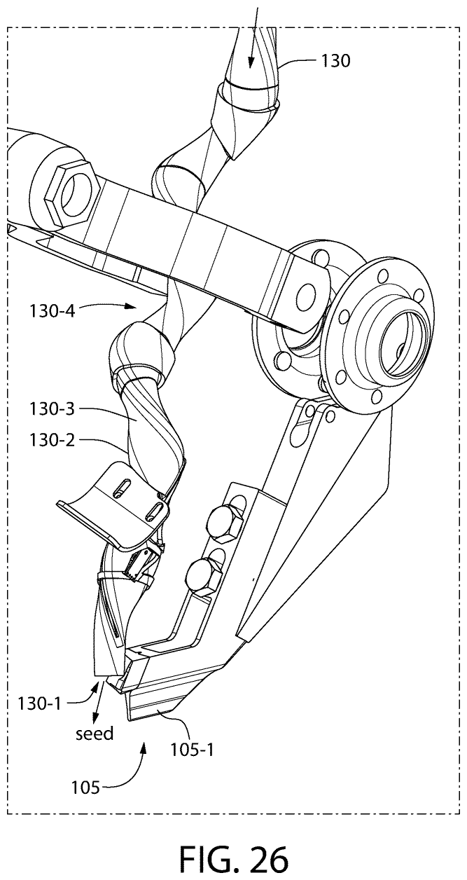

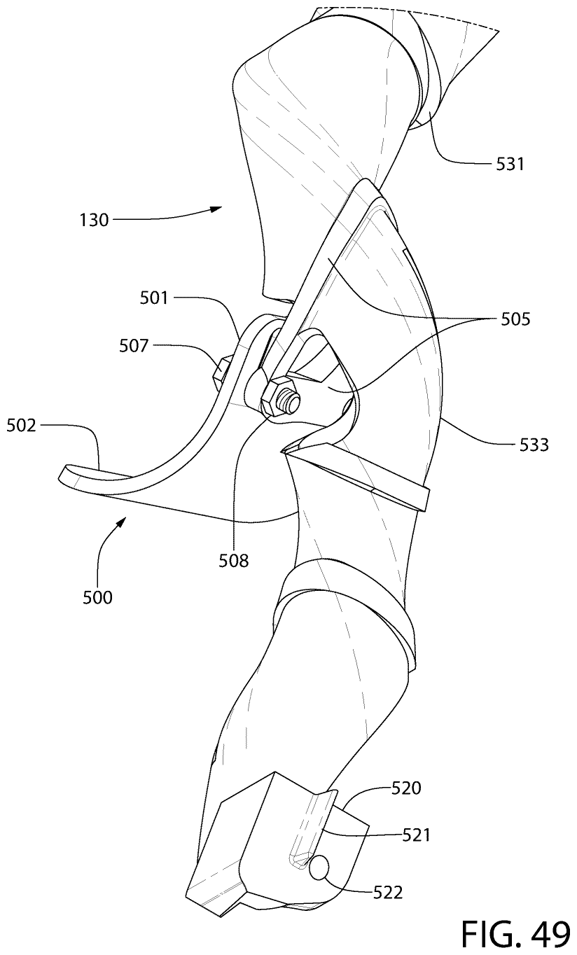

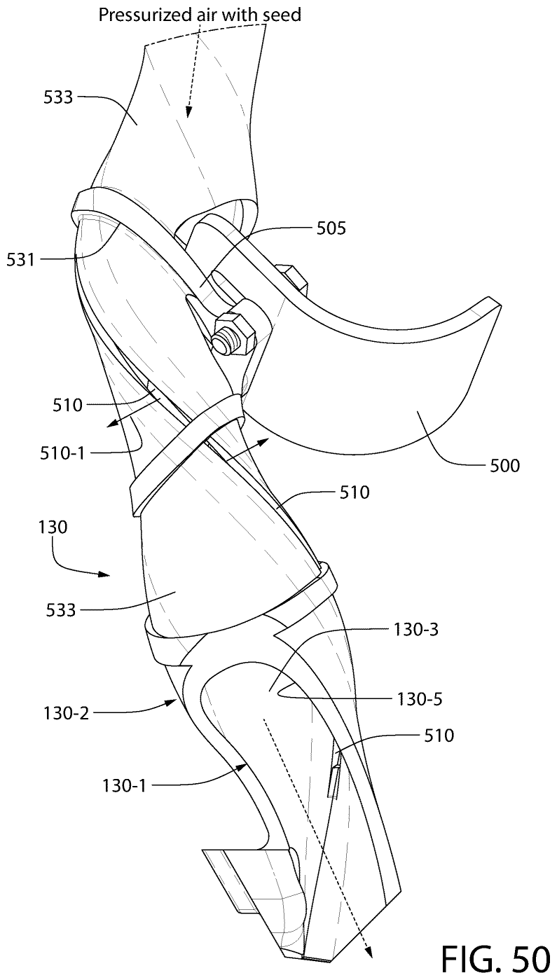

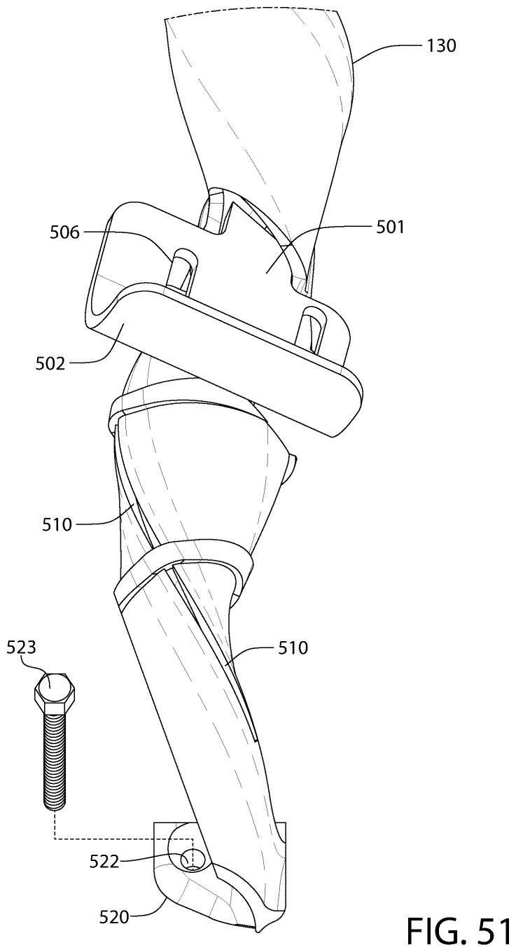

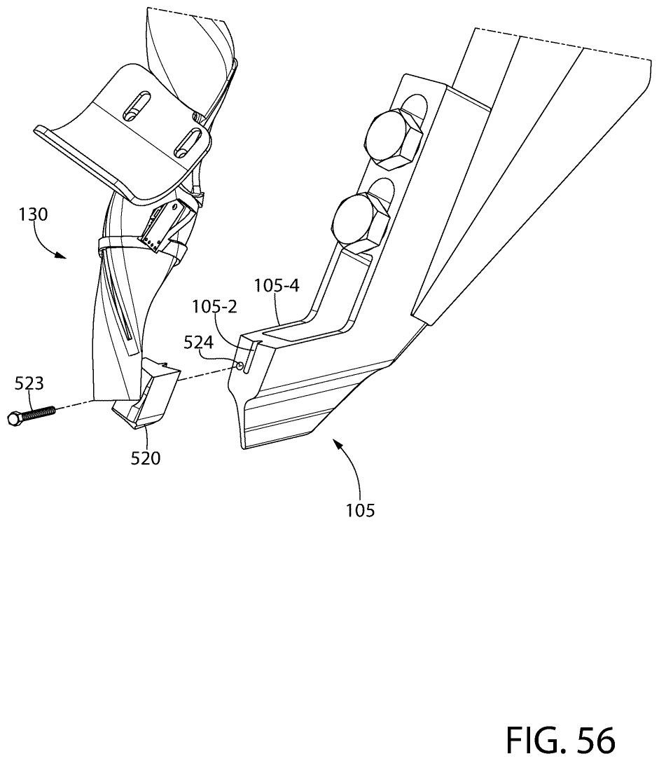

In embodiments including the optional sub-trench opener 105, the bottom end of seed dispensing tube 130 may be detachably coupled to the sub-trench opener for support when the tube travels through the planting trench 104. Referring to FIGS. 26, 49, 51, and 55-56, dispensing tube 130 includes a stabilizing block 520 disposed on the front side of the bottom of dispensing tube 130 near the discharge opening 130-1. In one embodiment, stabilizing block 520 may be detachably coupled to adjustable portion 105-4 of sub-trench opener 105 via a threaded fastener 523 which is inserted through fastener hole 522 in the stabilizing block and mating rearwardly open threaded fastener hole 524 in the adjustable portion (see, e.g., FIG. 56). Other threaded coupling arrangements may be used.

To further stabilize the coupling using only a single fastener 523, stabilizing block 520 may include a forwardly projecting key 521 which is received in rearwardly open keyway 105-2 formed at the rear end of the sub-trench opener mounting bracket 105-3. Key 521 and keyway 105-2 may be vertically elongated and oriented in one embodiment as shown. The key and keyway may be V-shaped in one configuration; however, other suitable complementary configurations may be used. In other embodiments, the key and keyway may be omitted and a pair of threaded fasteners 523 may instead be used to provide stable securement of the seed dispensing tube stabilizing block 520 to the sub-trench opener 105. In addition, other means may be used to fixedly couple the seed dispensing tube 130 to sub-trench opener 105.

In operation, when the stabilizing block 520 is coupled and keyed to the sub-trench opener 105 in the above manner, horizontal and vertical movement of the dispensing tube 130 is inhibited via the rigid coupling therebetween. This protects the bottom end of seed dispensing tube 130 from damage in the event the sub-trench opener blade 105-1 forward of the tube encounters debris in the agricultural field as the row unit forms the planting trench 104.

FIGS. 25-26 show the lower helical portion of seed dispensing tube 130 including a twisted fully enclosed top portion 130-4 and a partially open helical bottom portion 130-2 both of which include the internal helical seed orientation surfaces 130-3. The bottom discharge opening 130-1 is defined at the bottom end of the partially open helical bottom portion 130-2 of the tube 130 as shown enlarged in FIG. 26 and FIG. 50. Discharge opening 130-1 of the seed dispensing tube is downwardly open, and in one embodiment may comprise a vertically-oriented oblong lateral aperture 130-5 which extends upwards for a distance along tube 130 from the open bottom terminal end thereof. In one embodiment, lateral aperture 130-5 may face laterally outwards being formed in the right or left lateral side of seed dispensing tube 130 (best shown in FIG. 50). Advantageously, the lateral aperture 130-5 helps diffuse excess air traveling downwards inside the seed dispensing tube 130 to atmosphere which reduces the velocity of the airstream carrying the seed to promote proper implantation and orientation of the seed in the planting trench. In other possible embodiments, however, the seed dispensing tube 130 may be fully enclosed all the way down to the bottom end that defines the downwardly open discharge opening 130-1 by eliminating the lateral aperture 130-5. Accordingly, numerous variations of seed dispensing tube geometry and configuration are possible to suit the desired application.

In one embodiment, seed dispensing tube 130 may have a one-piece monolithic unitary body structure including the straight and helical portions shown. In the illustrated embodiment, the seed dispensing tube has a segmented body structure comprising a plurality of tube segments 533 coupled together at joints 531 (see, e.g., FIG. 50). Any suitable method may be used to coupled the segments together, such as for example without limitation welding, adhesives, bolted joints, quick-coupling type compression joints, etc. The dispensing tube whether one-piece or segmented structure may be formed of any suitable metallic or non-metallic material. In one non-limiting embodiment, dispensing tube 130 is formed of plastic.

In other embodiments, seed dispensing tube 130 can be configured as a seed orientation tube in which the seed rides/slides along an inside surface of the seed orientation tube and air flowing over the seed orients the seed to the desired orientation for delivery to the planting trench. Examples of orientation systems include PCT Publication Nos. WO2018013858A1, WO2018013859A1, WO2018013860A2, and WO2018013861A1. In other embodiments, a seed orientation device such as those described in U.S. Patent Publication No. US2020/0367425A1 and US2022/0192079A1 may be used on conjunction with seed dispensing tube 130 to orient the seeds after discharge from seed meter 128 and the seed dispensing tube before deposition in the planting trench.

Seed meter cover 127 may have a complementary configured curvature approximating the curvature of the seed path of travel P within seed meter 128. Seed meter cover 127 allows seed coming directly off of a desired singulated seed spot within seed meter 128 to enter into seed dispensing tube 130 with air assist via seed accelerator 300, while any other seed or debris that might be in the vicinity of either the desired seed or the seed entrance to seed dispensing tube 130 will be deflected by seed meter cover 207.

### Air Entrainment Seed Accelerator—Inside to Outward Airflow

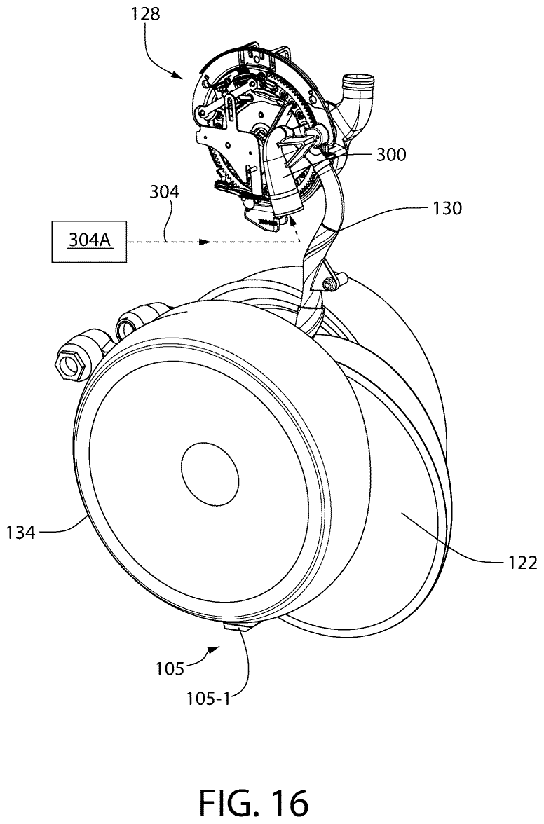

FIGS. 16-23 depict the first non-limiting embodiment of a seed accelerator 300 in greater detail and focus. Seed accelerator 300 comprises a curved and generally tubular body 300-1 configured to operate via air entrainment to strip and capture a singulated seed off metering disc of seed meter 128 and discharge the entrained seed into seed dispensing tube 130 for delivery to the planting trench. The seed accelerator body defines an internal passageway 300-2 thus configured to capture the seed via air induction. Seed accelerator 300 generally comprises an air inlet tube 301, air discharge tube 302, and a recurvant tube bend 303 extending therebetween. Air inlet tube 301 may be funnel shaped in one embodiment as shown having a frustoconical configuration with a larger entrance portion than the discharge portion adjoining tube bend 303. The funnel shape with gradually reducing diameter accelerates incoming pressured air supplied to the air inlet tube from a pressurized air source 304A to positively dislodge and strip a seed from each seed hole 129-2 of seed metering disc 129 as it rotates past the seed accelerator 300 which defines a discharge point on the metering disc. Inlet tube 301 is configured for coupling to an air supply conduit 304 such as an air hose or tube coupled to the pressurized air source 304A such as an air compressor or pressurized air tank (shown schematically in FIG. 16). Discharge tube 302 is configured for coupling to seed dispensing tube 130 as shown.

Seed accelerator 300 further comprises a seed capture shroud 305 configured to cover a portion of the seed metering disc 129. Shroud 305 creates a seed capture zone or region through which seeds carried by the metering disc pass as the disc rotates and are entrained in the pressurized airstream flowing through the shroud. The seed capture shroud may be disposed in the tube bend 303 between the air inlet and discharge tubes 301, 302 as shown in one embodiment.

The seed capture shroud 305 have a non-circular shape, and more particularly may have a polygonal shape in certain preferred but non-limiting embodiments. In the non-limiting illustrated embodiment, shroud 305 may be a 3-sided rectilinear structure (e.g., rectangular or square) in one embodiment comprising a pair of opposing end walls 305-1 and a transverse wall 305-2 connected to the opposing walls. Shroud 305 may be generally U-shaped in one embodiment as shown; however, other shapes may be used. Walls 305-1 and 305-2 is an orthogonal arrangement of walls. The walls 305-1 and 305-2 may each be flat as shown in the illustrated embodiment. However, in other embodiments transverse wall 305-2 may be arcuately curved and arched between the end walls. Walls 305-1 are orientated parallel to major surface 129-3 of seed metering disc 129 on one side of the disc. Transverse wall 305-2 is orientated parallel to the major surface 129-3 of metering disc 129. The linear inner edges of walls 305-1 are disposed proximate to major surface 129-3 of the metering disc to minimize air escape between the walls and disc.

Shroud 305 defines an inwardly open air entrainment chamber 306 facing towards seed metering disc 129. Air entrainment chamber 306 defines a portion of the internal passageway 300-2 of seed accelerator 300 through which pressurized air is introduced and flows therethrough. Chamber 306 may have a different cross-sectional shape than the internal passageway 300-2 of the air inlet and outlet tubes 301, 302. Chamber 306 may have a polygonal (e.g., rectilinear or other) cross-sectional shape as shown in the non-limiting illustrated embodiment whereas the air inlet and outlet tubes 301, 302 which form other portions of the passageway 300-2 may have a non-polygonal cross-sectional shape such as circular or oval (albeit which may be of varying diameter in different parts of the tubes).

One end wall 305-1 on the upstream side of shroud 305 includes an air inlet port 307 for introducing pressurized air into cavity 306. The other opposite end wall 305-1 wall includes an air outlet port 308 for air exiting the shroud with the seeds entrained in the airstream which are then conveyed into air discharge tube 302 of seed accelerator 300. Shroud 305 further includes a top opening 305-3 and opposing bottom opening 305-4 each of which communicate with air entrainment chamber 306 of the shroud. These openings define a through passage 305-5 through which the seed holes 129-2 and seeds disposed at least partially therein on metering disc 129 pass as the disc rotates for capture by air flowing through the shroud 305.

Seed accelerator 300 may include one or more mounting brackets 310 configured to detachable fixedly coupling to any suitable available support surface of the row unit, such as for example without limitation a portion of support frame 110 to which seed meter 128 is mounted and/or the meter cover 127. Threaded fasteners may be used in one embodiment for mounting the seed accelerator to the support surfaces. Other mechanical fasteners or clips may be used.

Seed accelerator 300 may have a monolithic body 300-1 in one embodiment in which the mounting brackets 310, air inlet tube 301, recurvant tube bend 303, air discharge tube 302, and shroud 305 are formed as an integral unitary structural part of the body. The seed accelerator body may be formed of a suitable metallic material or non-metallic material (e.g., polymer) fabricated by any suitable method including casting or molding depending on the material used.

The seed accelerator 300 is configured to convey the airstream through the air entrainment chamber 306 of the seed capture shroud 305 from an inward to an outward and downward direction across the metering disc 129 to capture the seeds from the seed holes 129-2.

In operation, the seed holes 129-2 formed in seed metering disc 129 rotate and pass through the seed capture cavity 306 inside seed capture shroud 305 one-by-one as the disc rotates. As previously described herein, each seed is temporarily retained in its respective seed hole 129-2 by a vacuum drawn on the hole from the other major surface 129-4 of the seed metering disc 129 opposite to major surface 129-3 on which the seeds are deposited to pass through the seed accelerator 300.

Pressurized air enters internal passageway 300-2 of seed accelerator 300 via air inlet tube 301 from the outside of the peripheral edge 129-1 of metering disc 129 and flows in a recurvant airflow path PA changing and almost completely (<180 degrees) reversing direction in the passageway to then flow in an airflow path across the metering disc from inside to outside back towards the peripheral edge while crossing the seed path of travel P at the air entrainment chamber 306 inside shroud 305 (see, e.g., FIG. 22). The airflow path PA through internal passageway 350-2 is therefore summarized as from outside to inside of peripheral edge 129-1 of metering disc 129, and changing direction from inside to outside back towards the peripheral edge at a different edge location from where the air was introduced via inlet tube 301. The pressurized airstream is introduced into the air entrainment chamber 306 via air inlet port 307 in shroud 305 and flows across and generally parallel to major surface 129-3 of seed metering disc 129 and across the seed holes 129-2 and seeds therein as they pass in succession one-by-one through the shroud upon rotation of metering disc 129. Air entrainment chamber 306 of shroud 305 is configured to convey the airstream crosswise to a circular seed path of travel P on the metering disc as the metering disc rotates. The crosswise airflow over the seeds disrupts their seating in the seed holes 129-2 to more effectively entrain the seeds in the airstream. The airflow dislodges each seed from its respective seed hole and the seeds becomes inducted into and entrained in the airstream flowing through the shroud. The airstream sweeps and conveys the air-entrained seed through the shroud air outlet port 308 and into the seed dispensing tube 130 coupled to the air discharge tube 302 of the seed accelerator. Seeds may enter shroud 305 at approximately the 3 o'clock position on metering disc 129 where they are entrained in the airstream, and are then swept outwards and discharged from the disc via air outlet tube 302 at approximately the same 3 o'clock position (see, e.g., FIG. 22). The seeds are discharged one-by-one from the bottom end of the seed dispensing tube 130 and deposited in the planting trench. Each seed on seed metering disc 129 is therefore stripped from the disc in succession and deposited in the planting trench as the seeds pass through the shroud 305 in a similar fashion to that described above.

Pressure and flow of air through seed accelerator 300 can be controlled to achieve a preselected seed and air velocity. At slow ground speed of the row unit, low air velocity is desired to prevent disturbing seeds once they are in the furrow. At high ground speeds, high seed velocity is desired to successfully trap seeds in a selected orientation. The seed velocity should be sufficiently greater than ground speed to make lateral motion of the seed relative to the ground negligible as the seed is being lodged into the planting trench.

### Air Entrainment Seed Accelerator—Outside to Inside Airflow

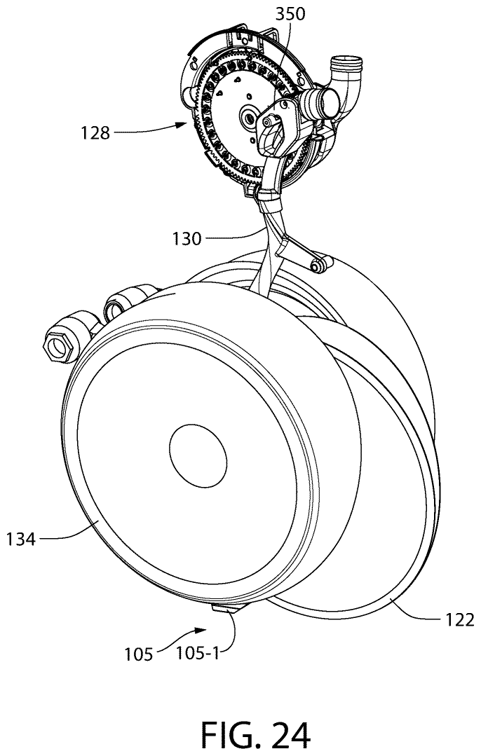

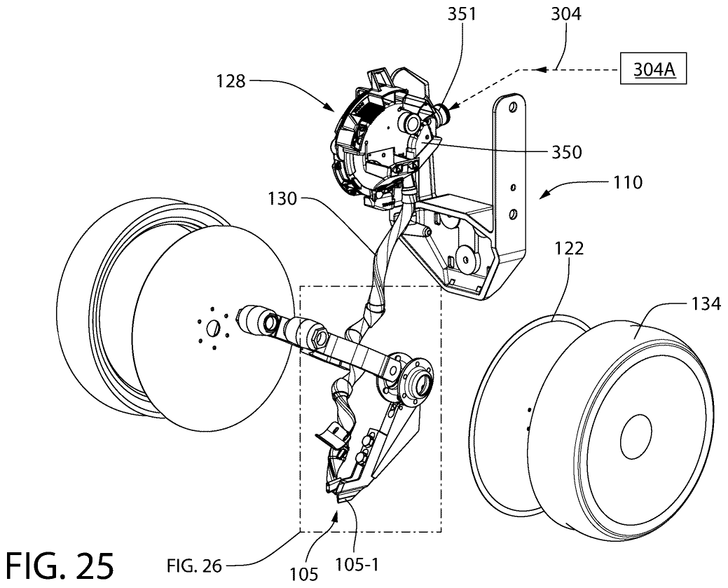

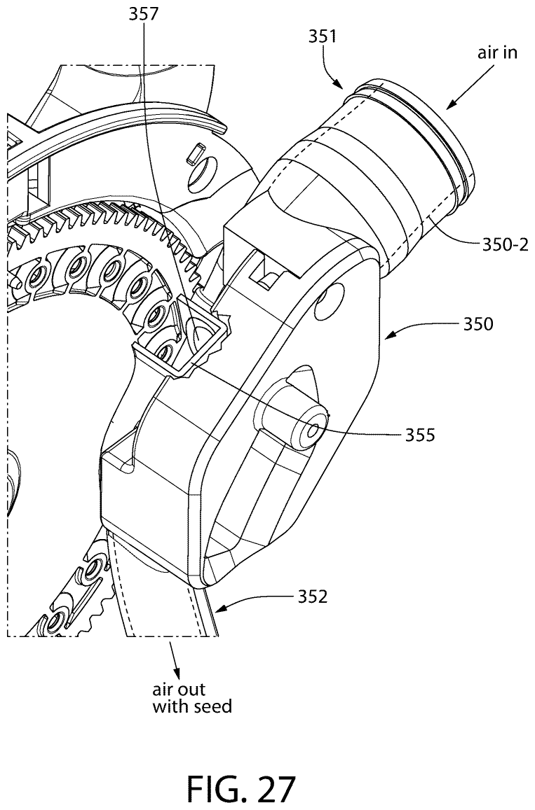

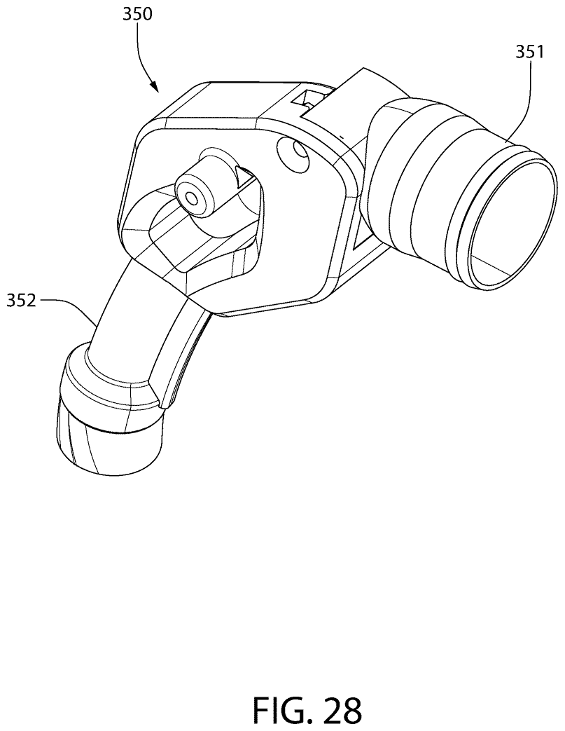

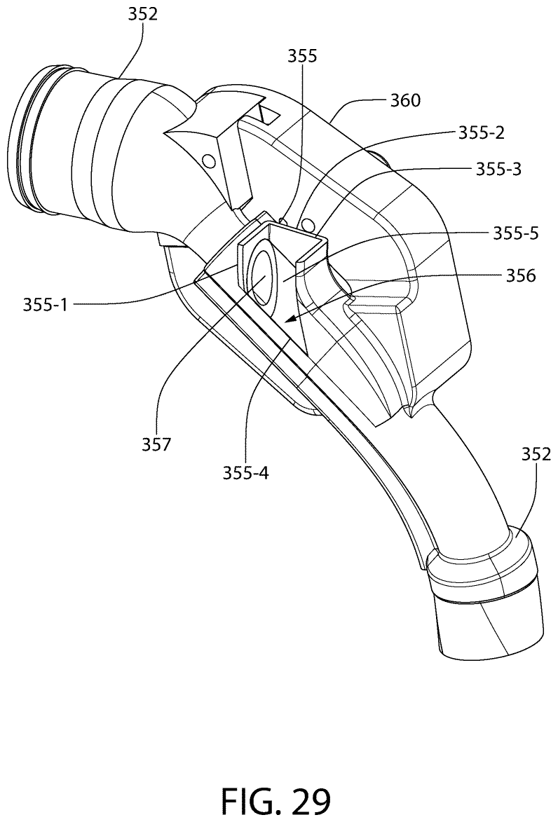

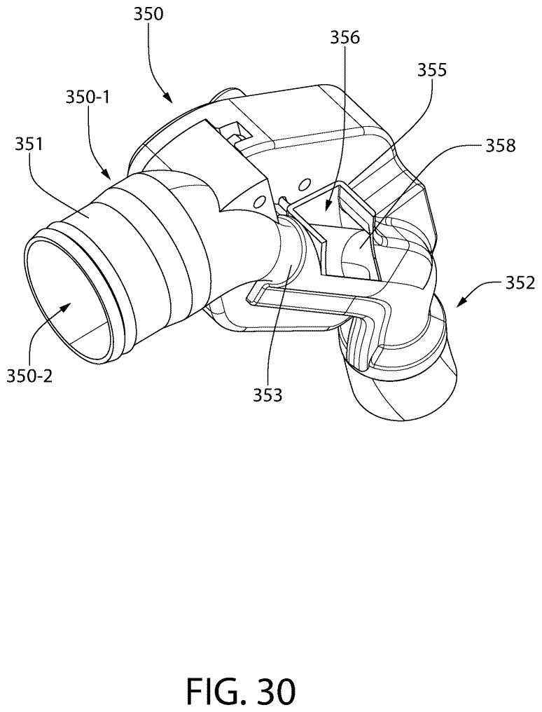

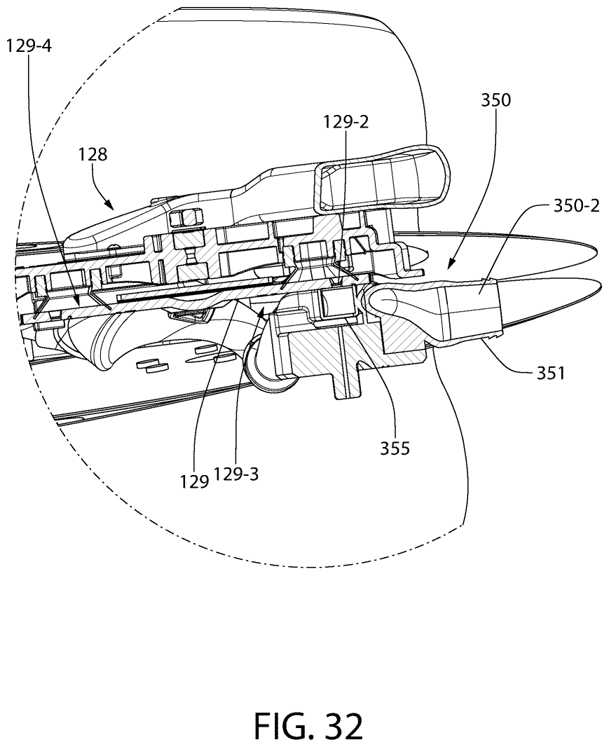

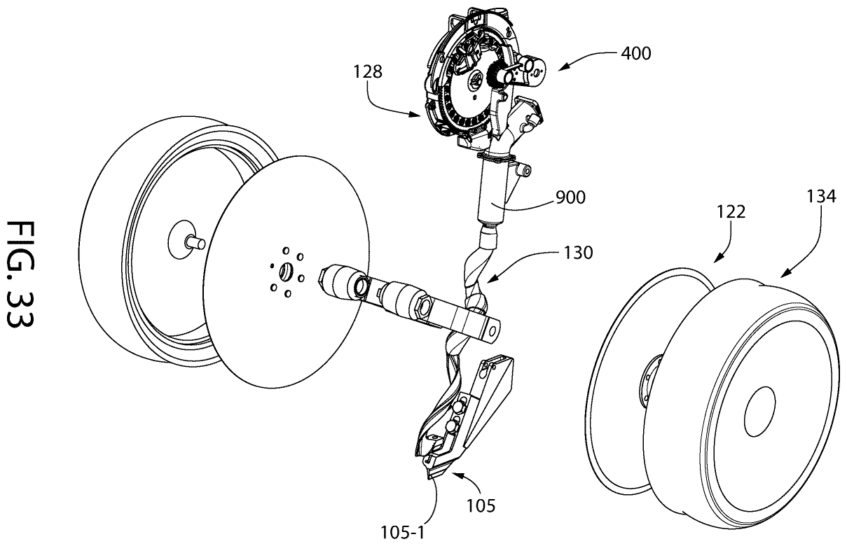

FIGS. 24-32 depict a second non-limiting embodiment of a seed accelerator 350 which comprises a curved and generally tubular body 350-1 configured to operate via air entrainment to strip a singulated seed off metering disc 129 of seed meter 128 and discharge the entrained seed into seed dispensing tube 130 for delivery to the planting trench. The seed accelerator body defines an internal passageway 350-2 thus configured to capture the seed via air induction. Seed accelerator 350 may function generally similar to seed accelerator 300 previously described herein and includes similar parts. However, the present seed accelerator 350 embodiment is configured and arranged to introduce pressured air across major surface 129-3 of seed metering disc 129 in an airflow path from outside the circumferential edge of the disc. The air flows across the disc 129 from edge to edge in a transverse direction instead of in a radially outward direction from inside the disc towards the circumferential edge of disc 129 like seed accelerator 300.

Seed accelerator 350 generally comprises an air inlet tube 351, air discharge tube 352, and an intermediate tube section 353 extending therebetween. Air inlet tube 351 may be funnel shaped in one embodiment as shown having a generally frustoconical configuration with a larger entrance portion than the discharge portion adjoining tube section 353. The funnel shape with gradually reducing diameter accelerates incoming pressured air supplied to the air inlet tube from a pressurized air source to positively dislodge and strip a seed from each seed hole 129-2 of seed metering disc 129 as it rotates past the seed accelerator 300. Inlet tube 301 is configured for coupling to an air supply conduit 304 such as an air hose or tube coupled to the pressurized air source 304A such as an air compressor or pressurized air tank (see, e.g., FIG. 25). Discharge tube 352 is configured for coupling to seed dispensing tube 130 as shown.

Both the air inlet and discharge tubes 351, 352 may be arcuately curved in one configuration as shown in the illustrated embodiment. Other configurations of the tubes may be used to deliver pressurized air in a transverse direction across the surface of the metering disc 129.

Seed accelerator 350 further comprises a seed capture shroud 355 configured to cover a portion of the seed metering disc 129. Shroud 355 functions in a similar manner to shroud 305 of seed accelerator 300 previously described herein. Accordingly, shroud 355 creates a seed capture zone or region through which seeds carried by the metering disc pass as the disc rotates. The capture shroud may be disposed in the intermediate tube section 353 between the air inlet and discharge tubes 351, 352 as shown in one embodiment.

The seed capture shroud 355 may be a 3-sided rectilinear structure (e.g., rectangular or square) in one embodiment similar to shroud 305 previously described herein. Shroud 355 therefore similar comprises a pair of opposing end walls 355-1 and a transverse wall 355-2 connected to the opposing end walls. Walls 355-1 and 355-2 is an orthogonal arrangement of walls. Shroud 355 may be generally U-shaped in one embodiment as shown; however, other shapes may be used. The walls 355-1 and 355-2 may each be flat as shown in the illustrated embodiment. However, in other embodiments transverse wall 355-2 may be arcuately curved and arched between the end walls. Walls 355-1 are orientated parallel to major surface 129-3 of seed metering disc 129 on one side of the disc. Transverse wall 355-2 is orientated parallel to the major surface 129-3 of metering disc 129. The linear inner edges of walls 355-1 are disposed proximate to major surface 129-3 of the metering disc to minimize air escape between the walls and disc.

Shroud 355 defines an inwardly open air entrainment chamber 356 facing towards seed metering disc 129. Chamber 356 may be configured similarly to chamber 306 of seed accelerator 300 previously described herein. Accordingly, the present air entrainment chamber 356 may have a different cross-sectional shape (e.g., rectilinear) than the internal passageway 350-2 of the air inlet and outlet tubes 351, 352 (e.g., circular).

One end wall 355-1 on the upstream side of shroud 355 includes an air inlet port 357 for introducing pressurized air into cavity 356. The other opposite end wall 355-1 wall includes an air outlet port 358 for air exiting the shroud with the seeds entrained in the airstream which are then discharged into air discharge tube 352 of seed accelerator 350. Shroud 355 further includes a top opening 355-3 and opposing bottom opening 355-4 each of which communicate with air entrainment chamber 356 of the shroud. These openings define a through passage 355-5 through which the seed holes 129-2 and seeds disposed at least partially therein on metering disc 129 pass as the disc rotates for capture by air flowing through the shroud 355.

Seed accelerator 350 may include one or more mounting brackets 360 configured to detachable fixedly coupling to any suitable available support surface of the row unit, such as for example without limitation a portion of support frame 110 to which seed meter 128 is mounted and/or the meter cover 127. Threaded fasteners may be used in one embodiment for mounting the seed accelerator to the support surfaces. Other mechanical fasteners or clips may be used.

Seed accelerator 350 may have a monolithic body 300-1 in one embodiment in which the mounting brackets 360, air inlet tube 351, intermediate tube section 353, air discharge tube 352, and shroud 355 are formed as an integral unitary structural part of the body. The seed accelerator body may be formed of a suitable metallic material or non-metallic material (e.g., polymer) fabricated by any suitable method including casting or molding depending on the material used.

In contrast to seed accelerator 300 previously described herein, the present seed accelerator 350 is configured to convey the airstream through the air entrainment chamber 356 of the seed capture shroud 355 from an outward to an inward and downward direction across the metering disc 129 to capture the seeds from the seed holes 129-2.

In operation, the seed holes 129-2 formed in seed metering disc 129 rotate and pass through the seed capture cavity 356 inside seed capture shroud 355 one-by-one as the disc rotates in rotational direction R. Each seed is temporarily retained in its respective seed hole 129-2 by a vacuum drawn on the hole from the other major surface 129-4 of the seed metering disc 129 opposite to major surface 129-3 on which the seeds are deposited to pass through the seed accelerator 350.

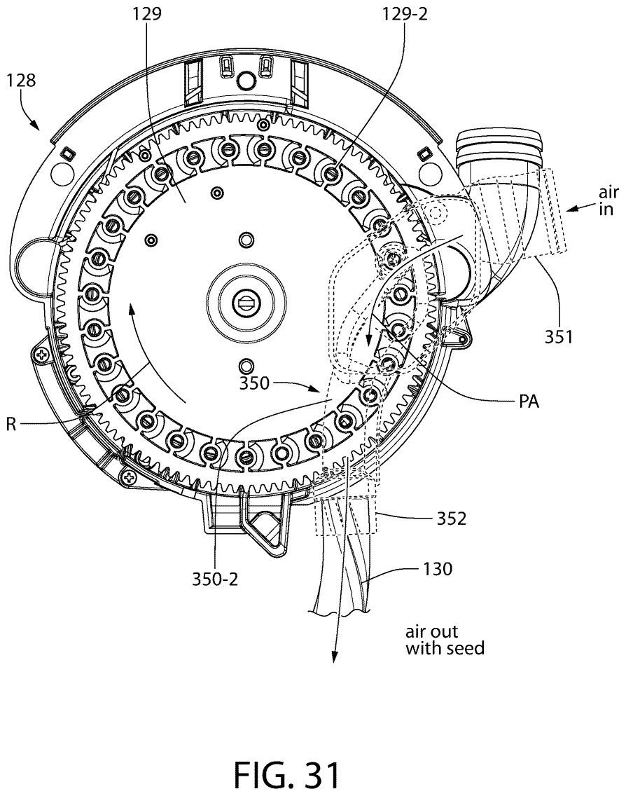

Pressurized air enters internal passageway 350-2 of seed accelerator 350 via air inlet tube 351 from the outside peripheral edge 129-1 of metering disc 129 at a first edge location and flows inwards generally following an arcuately curved airflow path PA to a second edge location while crossing the seed path of travel P at the air entrainment chamber 356 inside shroud 355 see, e.g., FIG. 31 airflow arrows). The airflow path PA through internal passageway 350-2 is therefore summarized as from outside to inside of peripheral edge 129-1 of metering disc 129, across the disc, and then inside to outside the peripheral edge. The pressurized airstream is introduced into the air entrainment chamber 356 via air inlet port 307 in shroud 355 and flows across and generally parallel to major surface 129-3 of seed metering disc 129, and across the seed holes 129-2 and seeds therein as they pass in succession one-by-one through the shroud upon rotation of metering disc 129. Air entrainment chamber 356 of shroud 355 is configured to convey the airstream crosswise to a circular seed path of travel P on the metering disc as the metering disc rotates, similarly to shroud 305 previously described herein. The airflow dislodges each seed from its respective seed hole and the seeds becomes inducted into and entrained in the airstream. In other embodiments, other mechanisms can be used alone or in combination for the seed removal. In one embodiment, a mechanical sweeping or scoop action such as in FR2414288 can be used. In another embodiment, the seed can just fall off the disc at the point that vacuum is terminated. The airstream sweeps and conveys the air-entrained seed through the shroud air outlet port 358 and into the seed dispensing tube 130 coupled to the air discharge tube 352 of the seed accelerator. Seeds may enter shroud 355 at approximately the 3 o'clock position on metering disc 129 where they are entrained in the airstream, and are then swept outwards and discharged from the disc via air outlet tube 352 at a different approximately 5 o'clock position (see, e.g., FIG. 31). The seeds are discharged one-by-one from the bottom end of the seed dispensing tube 130 and deposited in the planting trench.

### Mechanical Seed Accelerator—Wheel Embodiment

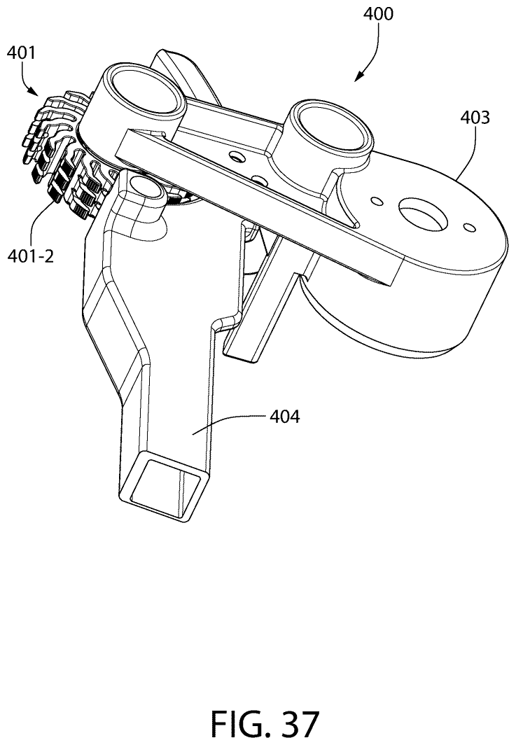

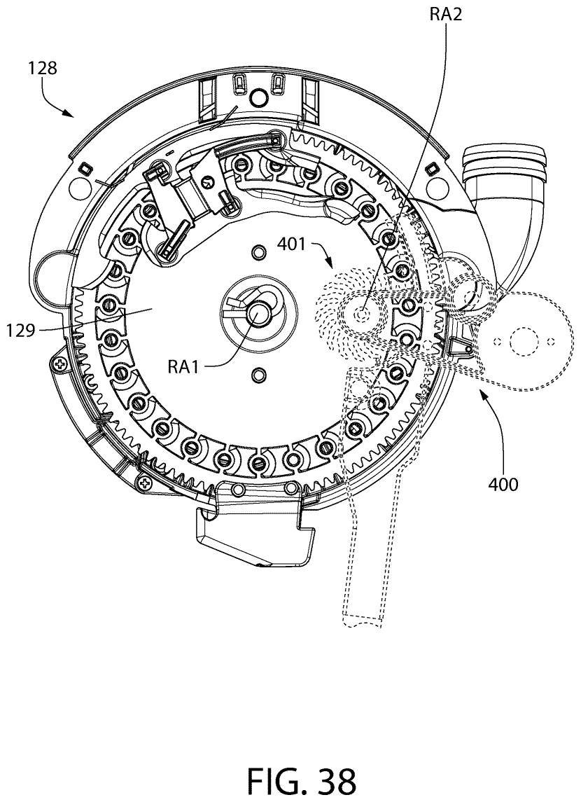

FIGS. 33-40 depict a non-limiting embodiment of a mechanical seed accelerator 400 which is configured to physically dislodge a singulated seed from metering disc 129 of seed meter 128 and discharge the seed into seed dispensing tube 130 rather than using pressured air as the motive force as in the prior air-operated seed accelerator embodiments disclosed herein.

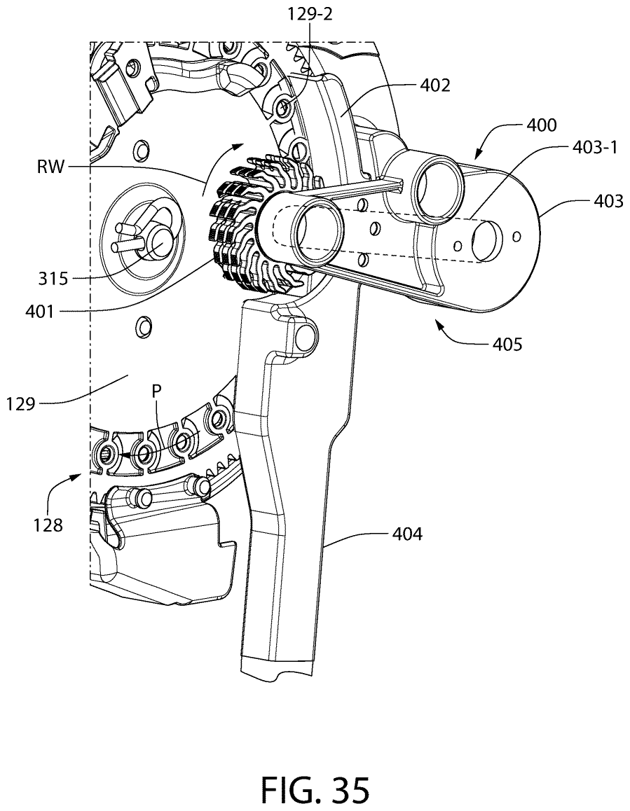

Seed accelerator 400 generally comprises a rotatable accelerator wheel 401, seed chute 404 comprising a seed guide wall 402, and electric motor wheel drive 403 coupled to the wheel and operably to rotate the wheel. The wheel, chute, and wheel drive may be supported by a common housing 405 configured for mounting to the seed meter and/or portion of the row unit frame. Wheel 401 is mounted about its central hub to drive shaft 401-1 coupled to wheel drive 403 such as via a mechanical coupling linkage 304-1 such as a commercially-available belt or chain in one embodiment (represented schematically in FIG. 35 by dashed lines). In other embodiments, the wheel drive system may be a direct drive in which the motor shaft is directly coupled to the drive shaft of the wheel 401.

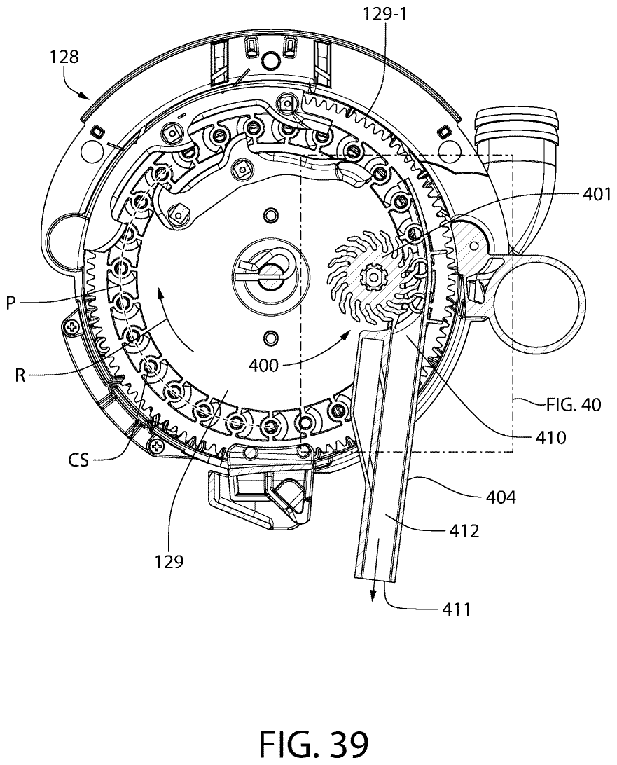

Drive shaft 401-1 of accelerator wheel 401 defines a rotational axis RA2 of the wheel which may be parallel to rotational axis RA1 of the metering disc 129 of seed meter 128 in some embodiments. The rotational axes RA1 and RA2 may be coplanar and lie in the same horizontal reference plane passing through and which includes the rotational axes (see, e.g., FIG. 39). The rotational speed (RPM-revolutions per minute) of accelerator wheel 401 may be greater than the rotational speed of the metering disc 129.

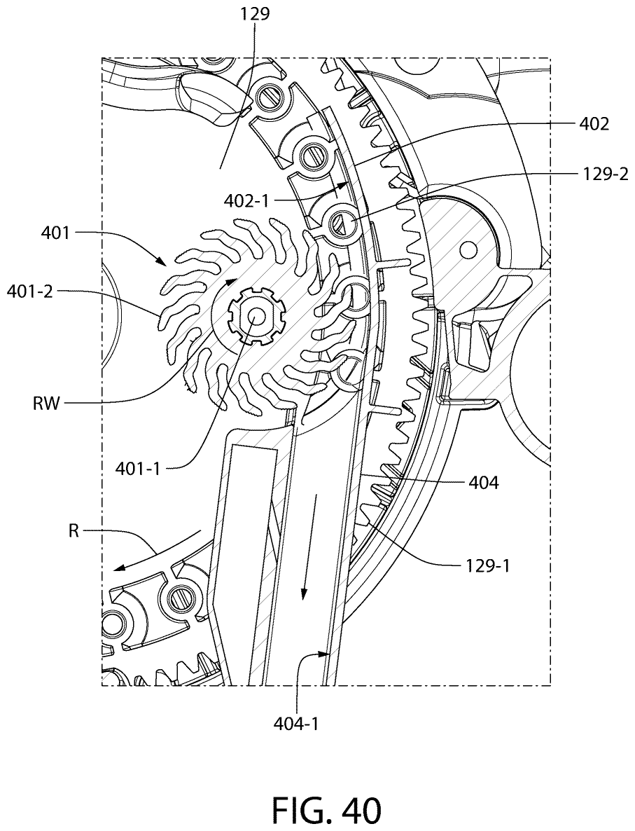

Accelerator wheel 401 comprises a plurality of arcuately curved radial fingers 401-2 configured to directly engage and dislodge a singulated seed from its seed hole. In other embodiments the fingers may be straight. Accordingly, the terminal free ends 401-3 of the fingers are positioned to pass over and intercept the seed holes 129-2 for that purpose as metering disc 129 rotates with rotation of the accelerator wheel 401 (see, e.g., FIG. 40). Examples of acceleration wheels which may be used are described in PCT Publication Nos. WO2013/049198, WO2014/018717, and WO2017/011675, and are available in the SpeedTube™ system from Precision Planting LLC of Tremont, Illinois.

In one embodiment, at least drive shaft 401-1 of accelerator wheel 401 (and concomitantly its rotational axis RA2) is located inboard of seed metering disc 129 (i.e. spaced inwards from the circumferential peripheral edge 129-1 of the disc). In the non-limiting illustrated embodiment, both drive shaft 401-1 and fingers 401-2 of accelerator wheel 401 (i.e. the entirety of the wheel) may be located inboard of the seed metering disc 129 peripheral edge 129-1 and spaced inwards from the peripheral edge. Viewed another way, accelerator wheel 401 has a rotational axis RA2 which is located inside seed path of travel P on the metering disc and guide wall 402 is located outside the seed path P. In either of the foregoing embodiments, accelerator wheel 401 dislodges and drives a singulated seed off of metering disc 129 in an outward radial direction towards peripheral edge 129-1 of the disc and against guide wall 402.

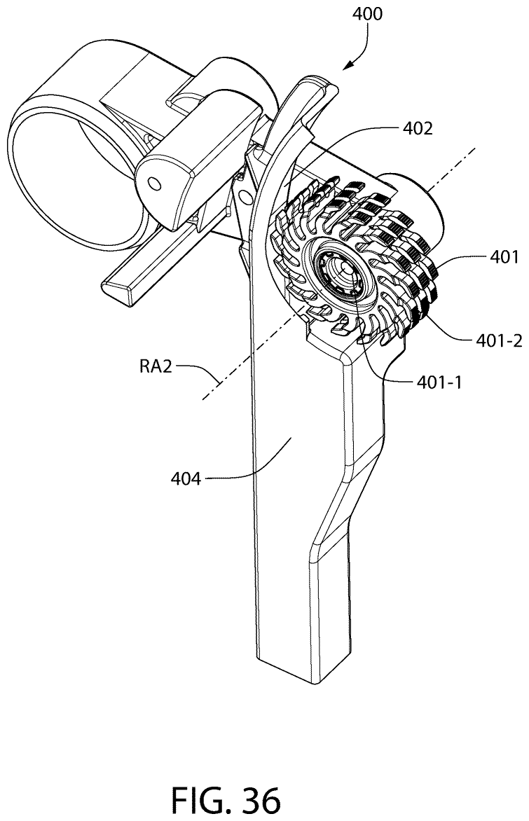

Guide wall 402 cooperates with the accelerator wheel 401 to accelerate the singulated seed dislodged by the wheel and dispense the seed into seed chute 404. Seed chute 404 in turn is coupled to seed dispensing tube 130 for discharging each seed in succession into the planting trough. The seed guide wall 402 may be arcuately curved in one embodiment as shown. Guide wall 402 defines an inward facing guide surface 402-1 facing accelerator wheel 401. Guide surface 402-1 may be formed as a contiguous portion with inner surface 404-1 of the seed chute 404 in embodiments as illustrated where the guide wall 402 and seed chute 404 are formed as integral unitary parts of the same single monolithic structure (see, e.g., FIG. 36). Guide wall 402 forms a protrusion extending upwards from entrance 410 of guide chute 404 and may be an open structure whereas portions of the chute 404 between its top entrance and bottom exit are fully enclosed as shown to guide the seeds into the adjoining and coupled seed dispensing tube 130.

The radial fingers 401-2 of accelerator wheel 401 compress the seed against wall 402 as the gap between terminal free ends of the fingers and guide surface 401-1 gradually narrows in the direction of rotation RW of the wheel 401. Fingers 401-2 may also be resiliently deformable in certain embodiments to both prevent crushing the seeds against the guide wall 402 and concomitantly to increase frictional grip on the seed which is ejected by the wheel as it rotates. Any suitable elastomeric material or other similar material with an elastic memory may be used to construct the fingers for this purpose. The curved fingers are separated by radial gaps to allow the fingers to become at least partially nested when deformed and collapsed inwards by compressing the seeds against guide wall 402. The fingers will spring back to their original undeformed condition via elastic memory to accelerate the seeds off the wheel 401 and guide wall 402 and the seeds are ejected. The resiliently deformable fingers 401-2 also allows the accelerator wheel 401 to accommodate seeds of different sizes/diameters for different types of plants to be planted. In other embodiments, however, the fingers may have a rigid construction when more suitable.

Accelerator wheel 401 in one embodiment may rotate in the same rotational direction RW as the rotational direction R of metering disc 129 (e.g., clockwise as shown in FIG. 40). Accordingly, the accelerator wheel 401 advantageously works in unison the existing rotational speed of metering disc 129 to further impart added acceleration to the seed for deposition in the seed trough. Viewed another way, the acceleration imparted by the accelerator wheel to the existing velocity of seeds rotating with the metering disc in seed holes 129-2 is additive to the rotational velocity of metering disc. To optimize the acceleration of the seed, the accelerator wheel 401 is located at a side position (e.g., approximately the 3 o'clock position) of the metering disc 129 to dislodge the seeds from the disc of the disc preferably before the seeds pass beneath the disc. In some embodiment, the rotational axis RA2 of accelerator wheel 401 may lie in the same horizontal reference plane as the rotational axis RA1 of the metering disc (see, e.g., FIG. 39). Seeds are dislodged from their seed holes 129-2 in a substantially tangential and downward direction to the peripheral edge 129-1 of the disc into seed chute 404. The added acceleration boost imparted to the seeds by accelerator wheel is particularly useful when at least part or all of the seed dispensing tube 130 contains helical seed orientation surfaces which increases sliding friction on the seeds thereby slowing the seed velocity.

It bears noting that the curved seed guide wall 402 in one embodiment may be configured in position and arrangement so as to not intersect the seed holes 129-2 or engage a seed as metering disc 129 rotates until fingers 401-2 of accelerator wheel 401 strikes and dislodges a singulated see from its seed hole. The guide wall 402 therefore does not function alone or first to physically dislodge the seeds from the disc, but rather cooperates with the accelerator wheel for that purpose.

In operation, the seed holes 129-2 formed in seed metering disc 129 rotate and pass between guide wall 402 and accelerator wheel 401 of seed accelerator 400. Fingers 401-2 of the wheel dislodge (in succession) each seed temporarily retained in its respective seed hole 129-2 by a vacuum drawn on the hole from the other major surface 129-4 of the seed metering disc 129 opposite to major surface 129-3 on which the seeds are deposited in the seed meter 128. Accelerator wheel 401 drives the seed radially outwards from metering disc 129 (see, e.g., FIGS. 39-40). Fingers 401-2 squeeze and compress each seed against the seed guide wall 402 (i.e. inner guide surface 402-1) for controlled capture and feeding of the seeds. The fingers, when resiliently deformable in structure, collapse inwards towards rotational axis RA2 to store potential energy therein, and the accelerator wheel accelerates the seeds via spring-like action when the fingers return to their un-collapsed condition. The seeds slideably engage guide surface 402-1 of the seed guide wall as the accelerator wheel rotates and move downwards in the vertical direction into seed chute 404 and then drops into seed dispensing tube 130 for implanting in a planting trough formed by the row unit in the agricultural field. The accelerator wheel 401 advantageously feeds the seeds in succession in a controlled manner at preselected time intervals as the wheel rotates to provide proper spacing of seeds in the trough. The seed spacing may be adjusted by selecting the appropriate rotational speed of the metering disc 129 and accelerator wheel.

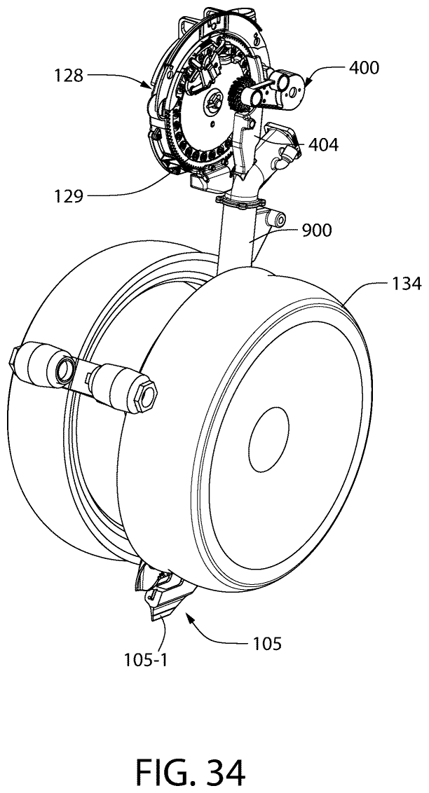

In some embodiments, the accelerator wheel 401 may be used in conjunction with air entrainment type seed accelerators 300 or 350 to feed the seeds from metering disc 129 into the accelerators for delivery to the seed dispensing tube 130 for planting. Illustrated in FIGS. 33 and 34 illustrate air entrainment seed accelerator 900 in conjunction with accelerator wheel 401.

Seed chute 404 and seed dispensing tube 130 are illustrated as discrete separated component, but may be formed and combined as an integral parts a single monolithic unitary structure operable for a similar purpose and benefit described herein.

In another embodiment, pressurized air source 304 can be operated to vary the pressure according to the speed of travel. The pressure can be directly matched with implement speed so that when speed increases, pressure increases, or when speed decreases, pressure decreases. This can be a continuous change, or it can be a step change so that there is a pressure for a subrange of speed. For example, there can be one pressure for a speed range of 1.6 to 3.2 kph (1-2 mph), another pressure for 3.2 to 4.8 kph (2 to 3 mph), and so on.

### Air Deflection Baffle and Vents

According to another aspect, planter row unit 100 may include at least one air deflection baffle 500. The air deflection baffle has a configuration operable to block and ejection at least a portion of air from entering the trench which may flow downwards along the seed dispensing tube 130. If not interrupted, this downward air flow along the seed dispensing tube may enter the seed trench 104 opened by the row unit and disrupt proper deposition and implantation of the seeds in the trench. The source of air is a fan, impeller, or compressor that provides pressurized air flow into the seed dispensing tube 130 such as via the air inlet tube 301.

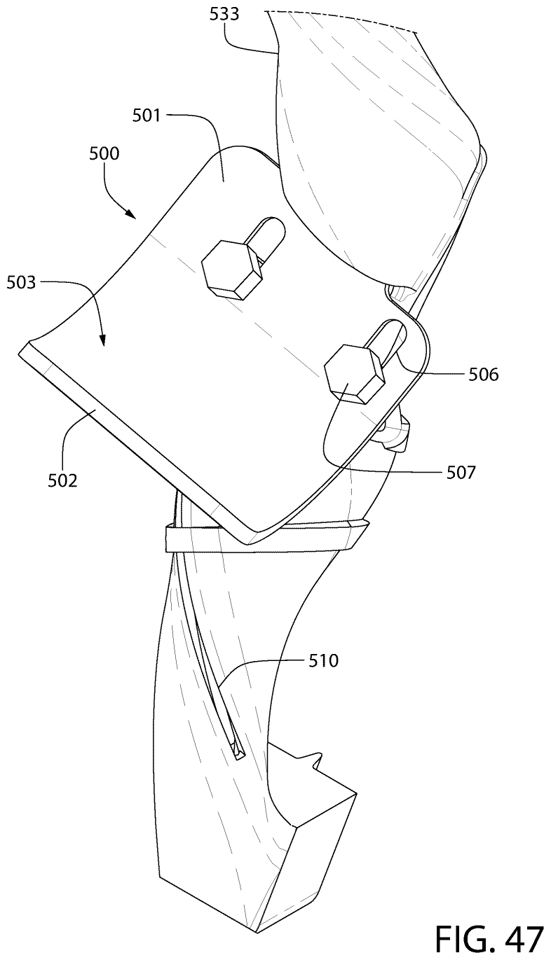

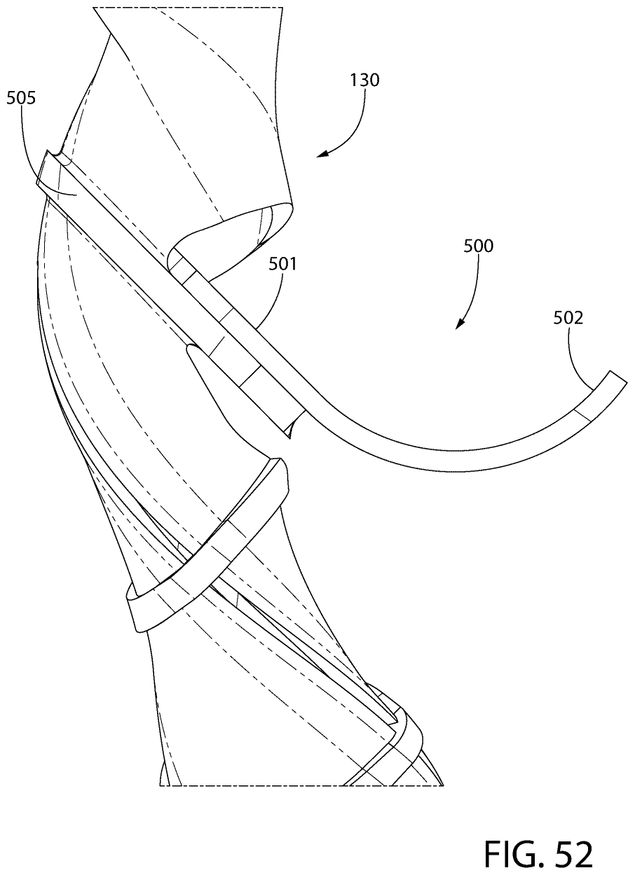

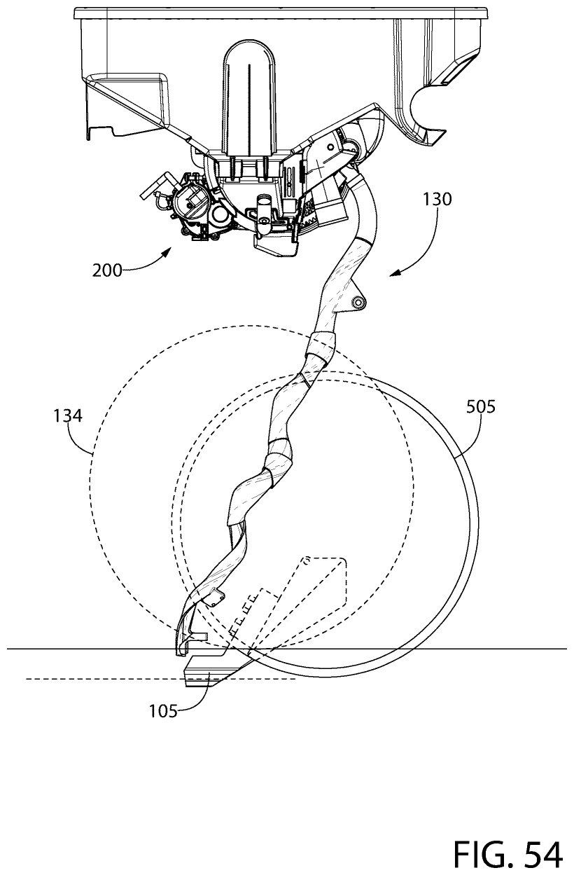

Referring to FIGS. 26 and 46-55, air deflection baffle 500 in some embodiment may be disposed adjacent the seed dispensing tube 130 between the top and bottom ends thereof, and more particularly on the lower portion of seed dispensing tube 130 located between the gauge wheels 134. In one implementation, baffle 500 may be mounted below the rotational wheel axis WA of the gauge wheels and positioned between the top of the seed trench 104 and wheel axis WA. Accordingly, air deflection baffle 500 may be mounted generally proximate to the bottom seed discharge opening 130-1 of the seed dispensing tube 130.

Air deflection baffle 500 in one embodiment comprises a mounting portion 501 which may be coupled to the seed dispensing tube 130 or the row unit support frame 110, and an air deflection portion 502 configured to direct air descending along exterior surfaces of the seed dispensing tube outwards away from the opened seed trench 104. Mounting portion 501 may be integrally formed with air deflection portion 502 such that the air deflection baffle comprises a monolithic unitary structure formed of a suitable metallic material or non-metallic material such as plastic. A metal-bodied baffle 500 is may be preferred for durability to withstand damage from rocks, debris, or residual crop material clumps which may be ejected from the soil by the opening discs 122 of row unit 100 when the trench is formed since the baffle is located proximate to the top of the trench between the gauge wheels 134.

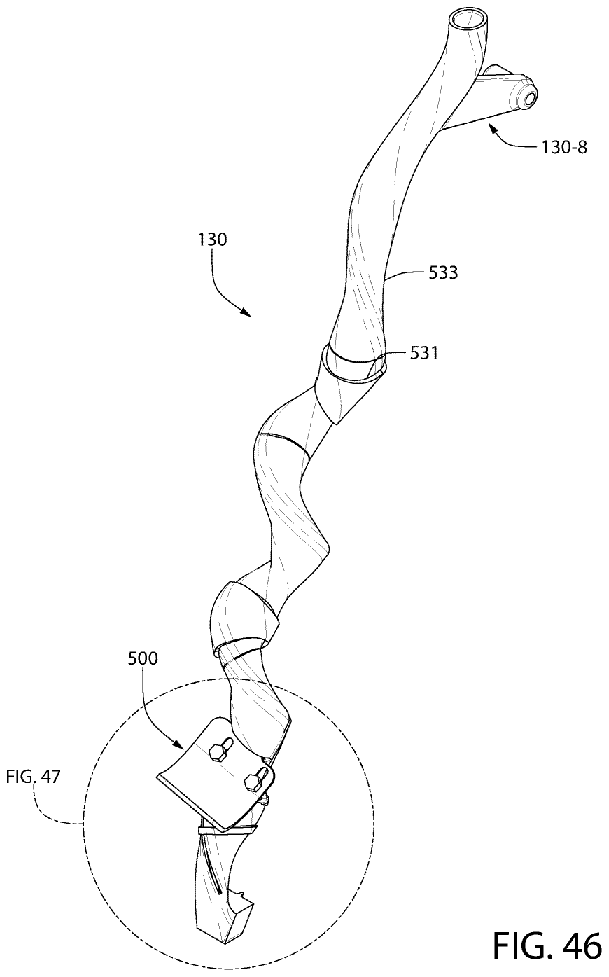

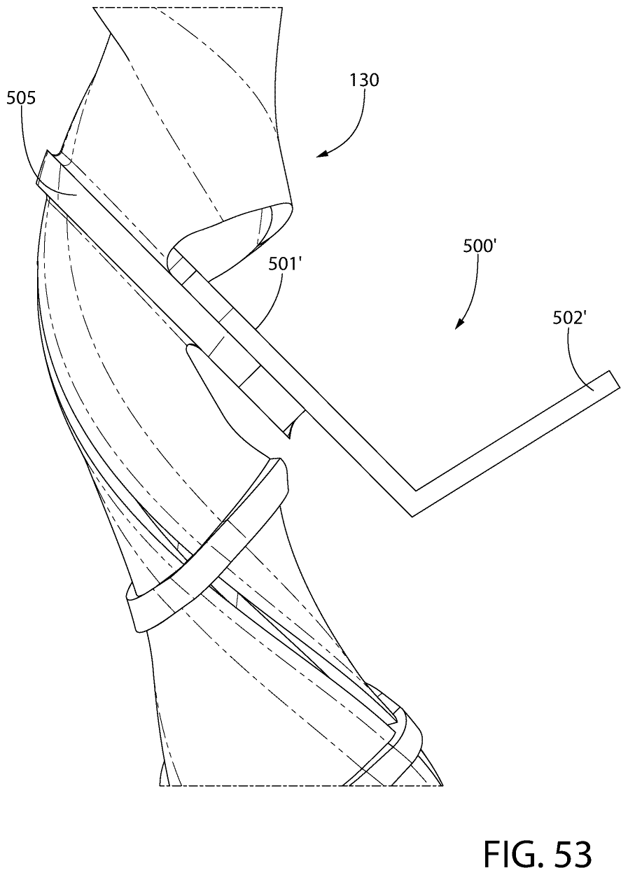

Air deflection portion 502 of the air deflection baffle comprises a curved air impingement surface 503 oriented transversely to and projecting outwards away from the seed dispensing tube 130. FIGS. 46-52 depict an arcuately curved embodiment of the air deflection baffle 500. FIG. 53 depicts an alternative sharply angled embodiment of a baffle 500′comprising a flat impingement surface 502′obliquely angled to the flat surface of the mounting portion 501′of the baffle. Either configuration of the baffles may constitute the curved air impingement surface 503 for deflecting air descending along the outer surface of the seed dispensing tube 130 away from the trench and seed discharge opening of the tube. Other configuration may be used which include compound shapes tailored to direct down-flowing air drafts away from the opened seed trench and discharge opening of the seed dispensing tube 130 within the trench.

In the non-limiting illustrated embodiment, air deflection baffle 500 may be detachably coupled to seed dispensing tube 130 via a mounting bracket 505 fixedly attached to the tube.

Mounting bracket 505 may be flange-shaped in one embodiment presenting a flat mounting face to the mating flat mounting portion 501 of air deflection baffle 500, thereby creating a flat-to-flat interface therebetween. Mounting bracket 505 may be fixedly affixed to the tube 130 via any suitable rigid coupling method such as welding, fasteners, or being formed as an integral unitary structural part of at least a portion of the tube. In the non-limiting illustrated embodiment, seed dispensing tube 130 has a segmented construction previously described herein. In this design, mounting bracket 505 is formed integrally with and on the end of one of the tube segments 533 at a joint 531 where the air deflection baffle 500 is to be mounted. In one embodiment, air deflection baffle 500 may be mounted to a lower helical portion of the seed dispensing tube 130 which defines the internal helical seed orientation surfaces 130-3.

In one embodiment, mounting portion 501 of air deflection baffle 500 may be coupled to mounting bracket 505 via one or more threaded fasteners 507. A pair of fasteners may be used in the one implementation as shown. In this case, a corresponding pair of fastening openings 506 are formed through mounting portion 501 to receive the fasteners. Openings 506 may be slot shaped in one embodiment to allow positional adjustment of the baffle 500 relative to seed dispensing tube 130, thereby forming a flat-to-flat sliding interface. Mounting bracket 505 on the dispensing tube includes a mating pair of circular fastener holes 509 to receive the threaded shanks of fasteners 507 therein or therethrough. In one embodiment, threaded fastener holes 509 may be provided. In other embodiments, fastener holes 509 may be unthreaded and nuts 508 as shown may be used to detachably couple air deflection baffle 500 to mounting bracket 505 via the fasteners. Other coupling means may be used to coupled the baffle to the mounting bracket in other embodiments.

In one embodiment, air deflection baffle 500 may be mounted on the rear side of seed dispensing tube 130 behind the sub-trench opener 105 and above discharge opening 130-1 at the bottom end of seed dispensing tube 130 from which the airstream-entrained seeds are deposited in the sub-trench at the bottom of the planting furrow or trench 104. This directs the air descending downwards along the seed dispensing tube 130 in the rearward direction away from the row unit and planting trench so as to not disturb the implantation and orientation of seeds in the trench. The rear side of the row unit 100 is rearwardly open between the gauge wheels 136 providing a convenient pathway to eject the air cleanly away from the trench and seed dispensing tube without inducing airflow turbulence within the seed dispensing region at the bottom of the seed dispensing tube 130. In other embodiments, air deflection baffle 500 may be located on other sides of the seed dispensing tube 130 such on the front side, either lateral side, or at positions partially between the rear, front, and lateral sides.

Seed dispensing tube 130 in some embodiments may further comprise at least one air vent 510 configured and operable to vent and diffuse a portion of pressurized air in excess flowing downwards inside the tube with entrained seeds to atmosphere. Multiple air vents 510 are provided in certain embodiments (see, e.g., FIG. 50). Vent(s) 510 further helps to prevent or minimize disruption of desired seed implantation in the planting trench by venting the excess air. When combined with the lateral aperture 130-5 in the tube helical bottom portion 130-2 previously described herein in some embodiments, the air vents 510 advantageously further reduces the velocity of the airstream carrying the seeds by decreasing the volume of air inside the tube. This contributes to proper implantation and orientation of the seed in the planting trench 104 when discharged from the tube.

The air vents 510 in one embodiment may be located in and through the helical bottom portion 130-2 of seed dispensing tube 130, and more particularly in certain embodiments at least some vents are located adjacent to and/or below air deflection baffle 500 on the tube (see, e.g., FIGS. 26 and 50). The vents place the inside of the seed dispensing tube 130 in fluid communication with ambient atmosphere to vent the pressurized air outwards as shown by directional airflow arrows 510-1. Vents 510 in one embodiment may comprise elongated slots which are laterally open and have a greater length than width. The vent openings are dimensioned smaller in width than the size of seeds entrained in the pressurized airstream inside seed dispensing tube 130 to retain the seeds within the tube since the seeds may slideably engage the inside tube walls. In one embodiment, the vents may further be helically twisted in configuration to follow and conform to the curving contour of the helical bottom portion 130-2 of tube 130 (see, e.g., FIG. 50). In other embodiments, at least one or all air vents may be located in any portion of seed dispensing tube 130 such as the upper portion thereof in addition to or instead of the lower portion of the tube.

In one embodiment, at least one of the air vent 510 may be located in the tube wall adjacent the oblong lateral aperture 130-5 formed at the bottom of seed dispensing tube 130 as shown in FIG. 50.

### Seed Firming Wheel

According to another aspect of the invention, a seed firming wheel assembly 600 may be provided to press the seeds deposited in the planting trench by row unit 100 into the soil at the bottom of the trench. This helps ensure that the seeds achieve uniform depth in the soil by pressing down seeds that may land higher up in the trench before the closing wheels 150 re-close the trench while the row unit moves along the planting row.

As the row unit 100 forms the planting trench and traverses the agricultural field, the firming wheel may bounce and move upwards/downwards due to undulations in planting trench and simply the rolling motion of the wheel. This can generate and transmit forces and vibrations back to the row unit, which is undesirable as it may adversely impact the structural integrity of the firming wheel mounting components. In addition, it is also desirable to keep the firming wheel pressed into rolling contact with soil at all times.

To address these issues, the present seed firming wheel assembly 600 comprises a resilient acting suspension system which supports the firming wheel. The suspension system is provided to ensure consistent force is applied by the wheel as the row unit traverses variable topography which results in undulations in the trench. A suspension system also provides relief when the wheel encounters obstacles such as rocks and crop residue in the agricultural field.

In one embodiment, the suspension system comprises a torsion axle 650 which supports the firming wheel, as further described herein. A torsion axle provides a limited degree of freedom in the vertical direction (wheel moving up and down). Furthermore, a torsion axle provides a limited degree of freedom in the horizontal direction (side to side) which helps ensure the wheel remains located properly and aligned with the trench, even as the row unit travels in a non-linear direction (around curves for instance).

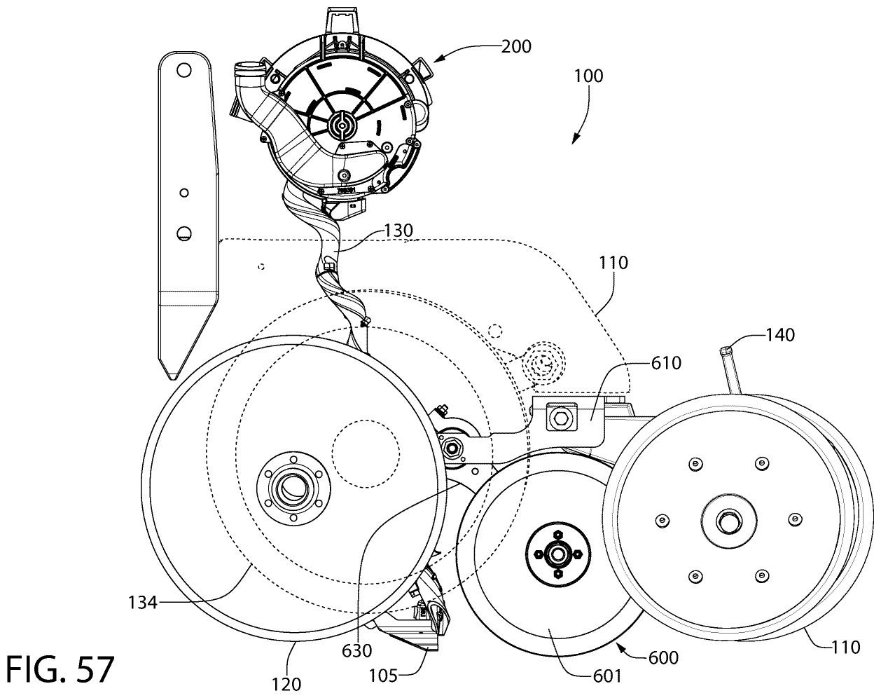

With initial reference to FIG. 57, the row unit 100 previously described herein is shown with a seed firming wheel assembly 600 which incorporates the torsion axle 650 suspension system. The seed firming wheel assembly may be mounted to a portion of the row unit frame 110. The firming wheel of the assembly is positioned between opening discs 120 and closing wheels 110. In embodiments having a sub-trench opener 105, firming wheel 601 is located behind the sub-trench opener and seed dispensing tube 130. A portion of the firming wheel may extend below the opening discs 120, closing wheels 110, and gauge wheels 134 in some embodiments to depress the dispensed seeds into the soil at the bottom of the sub-trench to a desired pre-selected depth of implantation.

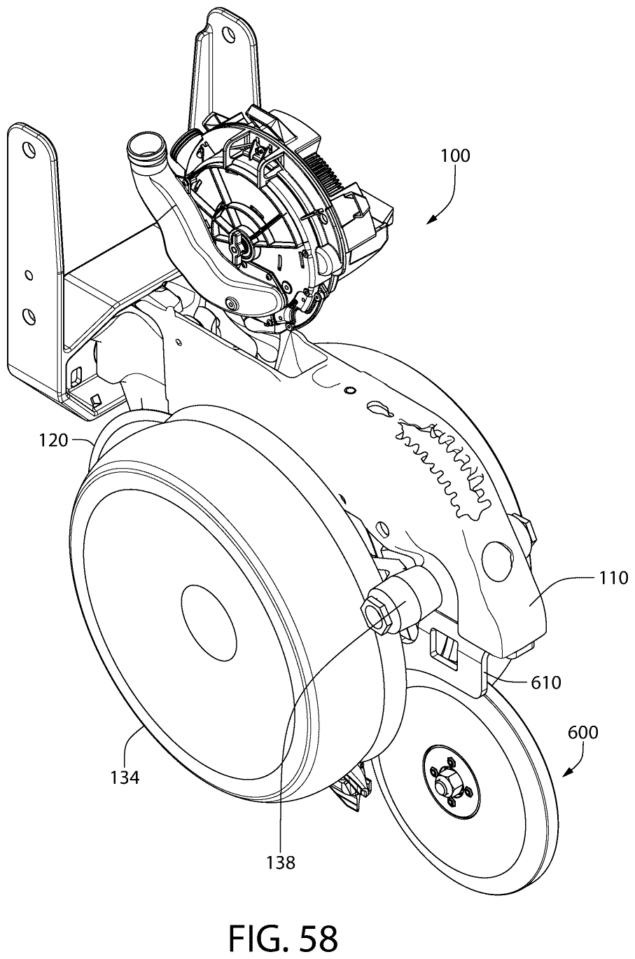

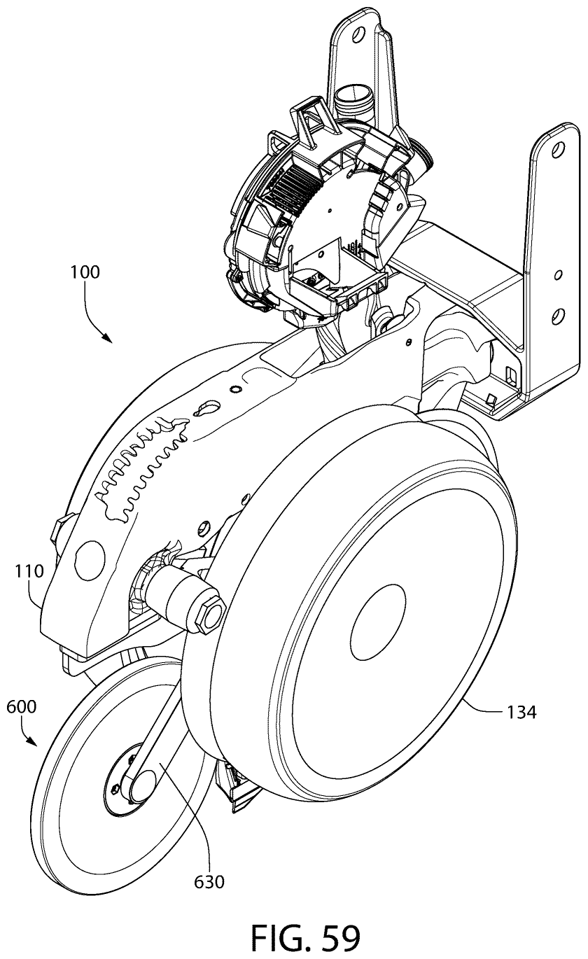

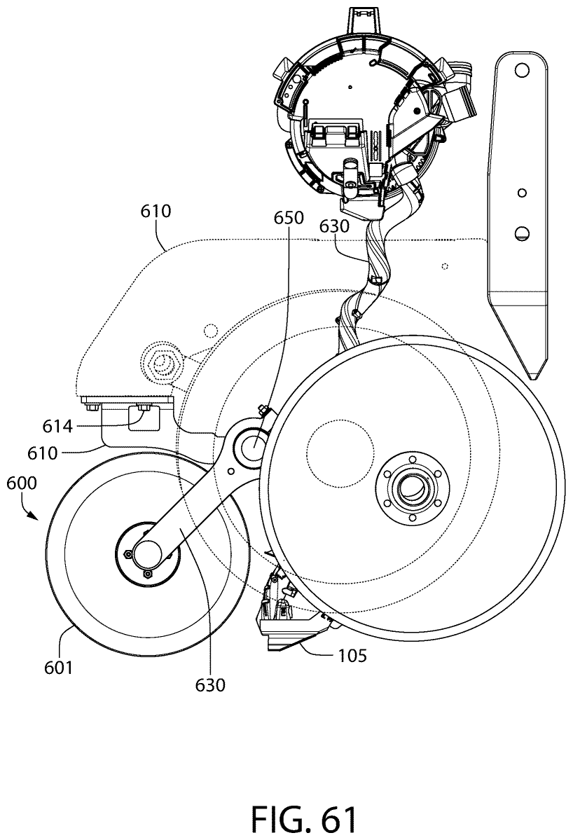

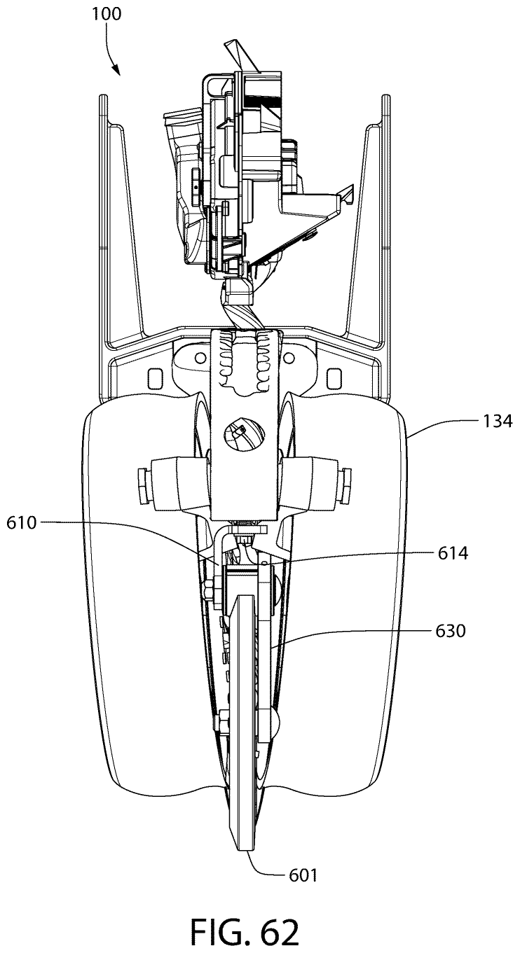

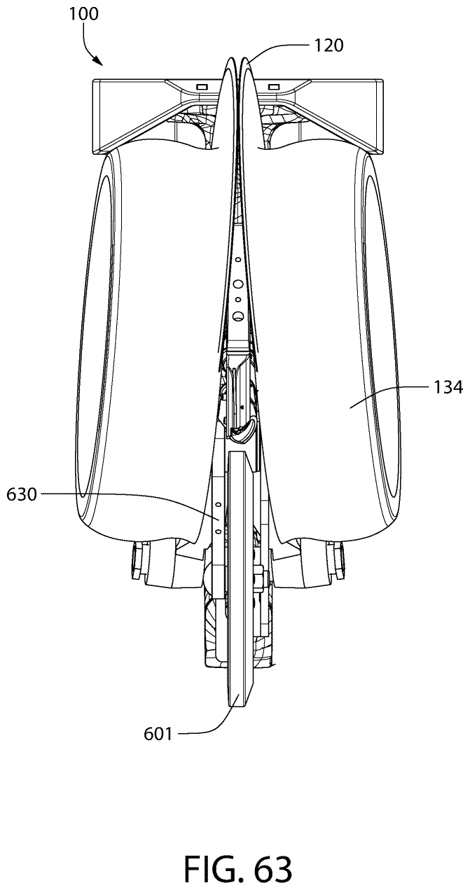

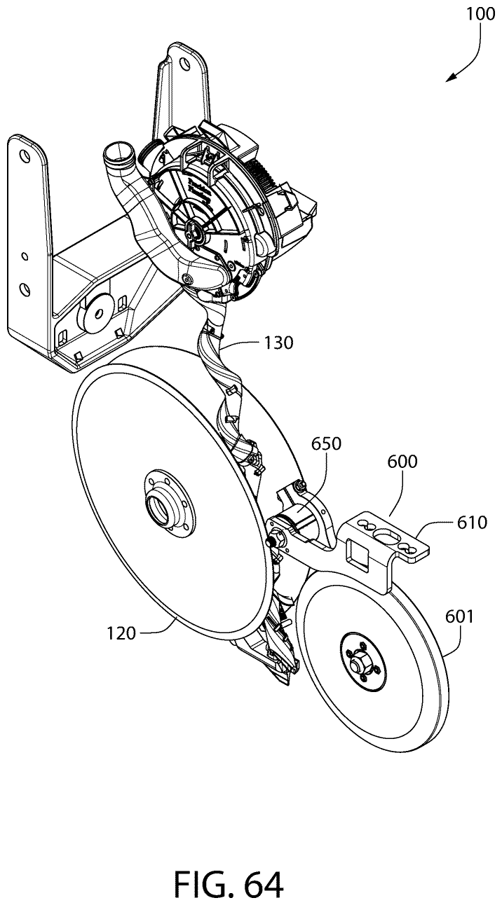

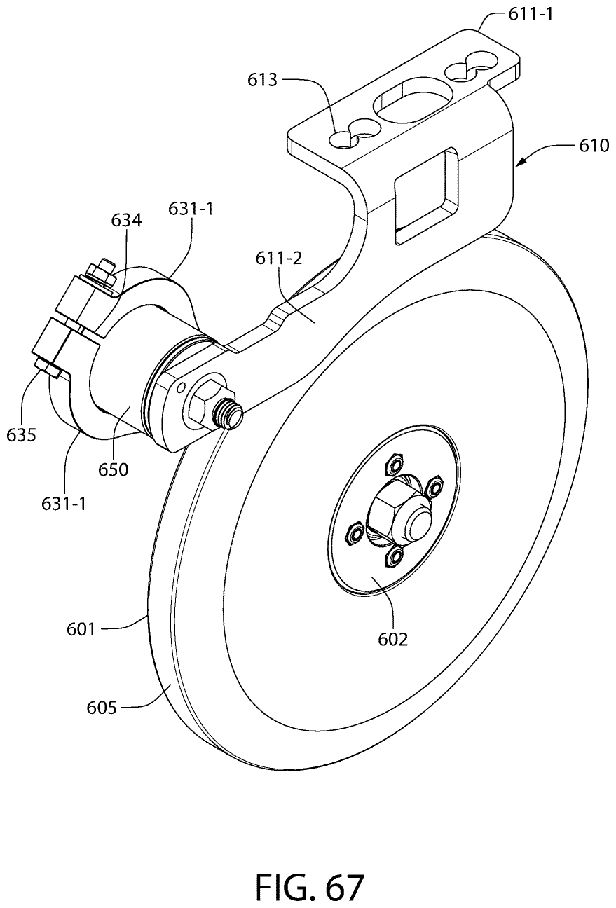

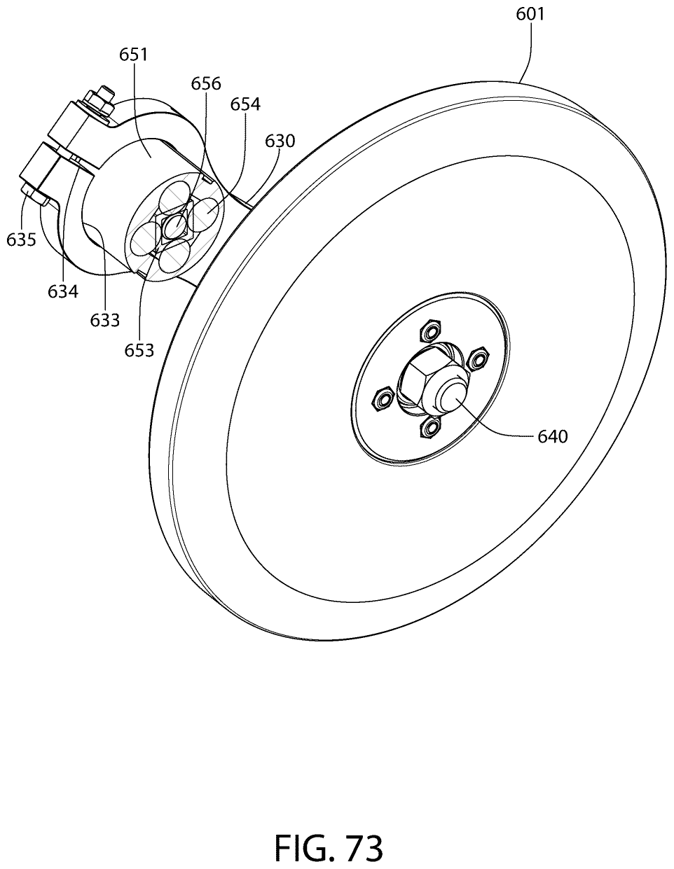

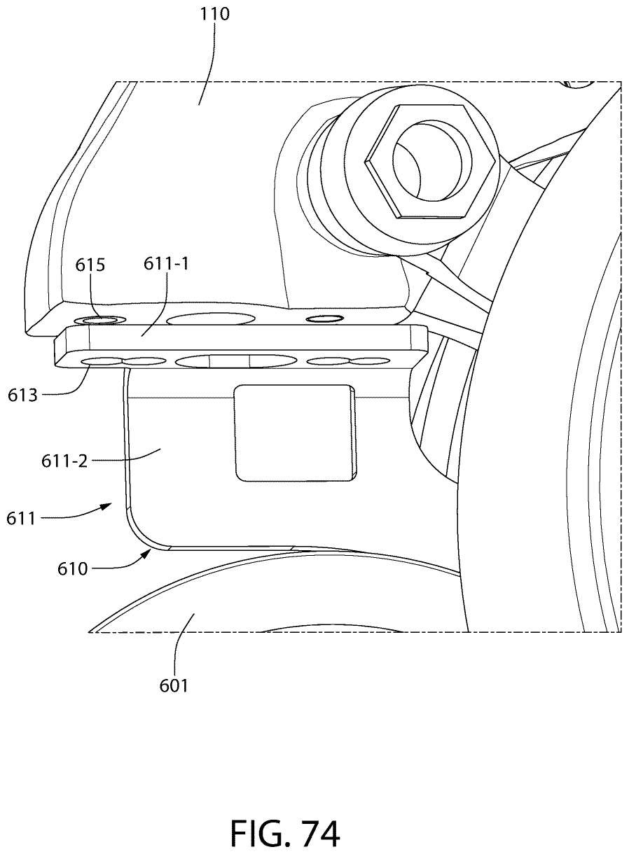

With additional general reference to FIGS. 58-74, the seed firming wheel assembly generally includes mounting bracket 610 coupled to row unit support frame 110, suspension arm 630 coupled thereto 630, and firming wheel 601 in turn rotatably coupled to the suspension arm. These components and the arrangement of the seed firming wheel assembly will now be described in further detail.

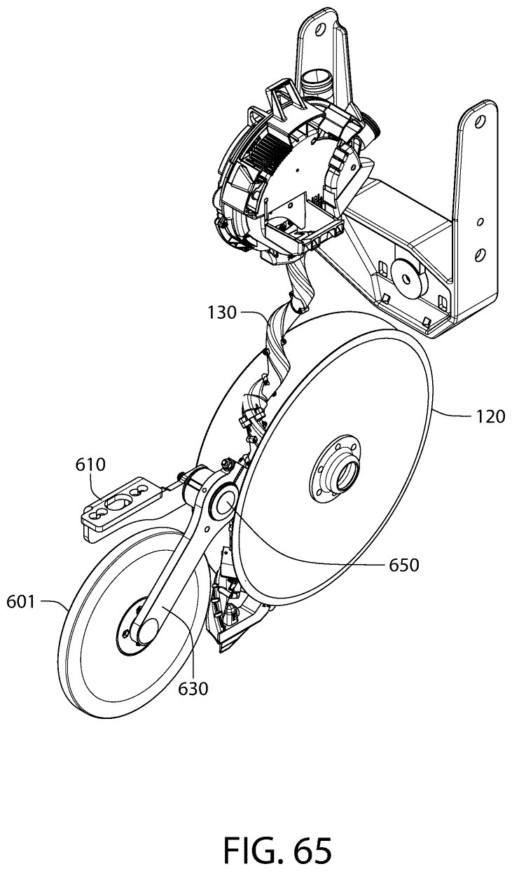

FIGS. 65-74 show details of the seed firming wheel assembly 600 isolated from the row unit for clarity.

Mounting bracket 610 couples the entire seed firming wheel assembly 600 to frame 110 of row unit 110. In one embodiment, the bracket may comprise an elongated body defining a centerline C1 and including a first end 611 configured to be rigidly coupled to row unit frame 110 as described below, and an opposite second end 612. End 612 may be a “free-floating” in one embodiment which is defined herein as such being unattached to the row unit frame or any other part of the row unit such that the mounting bracket 610 forms a cantilever.

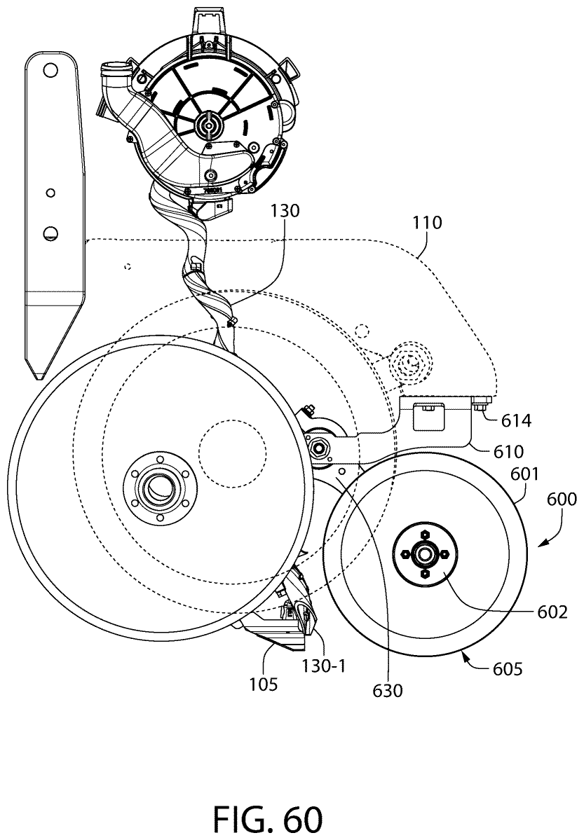

First end 611 of mounting bracket 610 in one embodiment may have an L-shaped configuration comprising a coupling portion 611-1 and an adjoining vertical portion 611-2. In one embodiment, vertical portion 611-2 may extend from end 611 to end 612 of mounting bracket 610 to provide a vertical surface for mounting torsion axle 650 thereto as further described herein. Coupling portion 611-1 may be horizontal and defines at least one pair of fastener holes 613 which receive threaded mounting fasteners 614 for coupling to the support frame 110 of the planting row unit 100 (see, e.g., FIG. 60). In the non-limiting illustrated embodiment, two pairs of closely spaced fastener holes each may be provided to provide some degree of mounting adjustment (e.g., front to rear) on frame 110 of row unit 100. Row unit frame 110 includes corresponding threaded bores 615 which receive fasteners 614 to couple mounting bracket 610 thereto in a fixed rigid manner. It bears noting that suspension arm 630 and firming wheel 601 are supported by this single point of coupling of the seed firming wheel assembly 600 to the row unit frame in the non-limiting illustrated embodiment.

In other possible embodiments, coupling portion 611-1 of mounting bracket 610 may be vertically oriented instead of horizontal such that the first end 611 may not have an L-shaped configuration. In such an embodiment, first end 611 may be straight and vertical in structure. Other possible configurations of the first end 611 of mounting bracket 610 may be used in other embodiments depending on the configuration of the portion of the row unit frame 110 to which the seed firming wheel assembly 600 is to be mounted. Accordingly, the invention is not limited in this regard.

In other less preferred but acceptable embodiments, coupling portion 611-1 of mounting bracket 610 may instead be welded to the row unit frame.

In one embodiment, the suspension system of firming wheel assembly 600 configured to support firming wheel 601 and dampen forces and vibrations induced by contact with the soil may comprise a torsion axle 650 which may be fixedly coupled to free-floating second end 612 of mounting bracket 610 in the non-limiting illustrated embodiment. The torsion axle is supported in a cantilevered manner by the mounting bracket 610 from the row unit frame 110 as shown. Accordingly, torsion axle 650 is not directly supported by or coupled to the row unit frame 110 in this embodiment. In certain other embodiments contemplated, second end 612 of mounting bracket 610 may instead be configured for mounting to row unit frame 110 if additional rigidity to support torsion axle 650 is desired and needed. The cantilevered embodiment illustrated however is beneficial because there are limited portions of the row unit frame available to which a bracket may be attached in view of the other components of the row unit which require support such as without limitation the opening discs 120, closing wheels 110, gauge wheels 134, seed dispensing tube 130, and sub-trench opener 105 (if provided). In addition, the unsupported second end 612 of mounting bracket 610 provided some degree of flexibility to withstand impact forces transmitted to the torsion axle 650 should the row unit 100 encounter hard obstacles embedded in the soil as the planting trough is being created.

In one embodiment, torsion axle 650 may comprise an outer housing 651, a centrally-located inner core member 653, and a plurality of resiliently compressible cord elements 654 spaced circumferentially apart around the inner core member inside the outer housing. Outer housing 651 may define a central passage 651-1 extending from end to end. The cord elements and inner core member are disposed therein. Outer housing 651 may be cylindrical with a circular cross-sectional shape in one embodiment; however, other shaped outer housings may be used including those with various polygonal cross-sectional shapes including rectilinear. The outer housing is not limited in this regard.

The cord elements 654 may be cylindrical and rod-shaped in one embodiment. Outer housing 651 may define a plurality of semi-circular channels 652 in one configuration which partially receive and hold the cord elements in circumferentially spaced apart relationship inside the housing. Four cord elements 654 may be provided in one embodiment as shown; however more cord elements may be used in other embodiments if needed. The cord elements may be formed of a suitable elastomeric material which may be synthetic (e.g., polymer) or natural (e.g., rubber) having elastic properties and memory to provide resiliently deformable element. This allows cord elements 654 to deform and compress when a load is applied via outer housing 651 to the torsion axle 650 by firming wheel 601, and return to its original condition when the load is sufficiently removed.

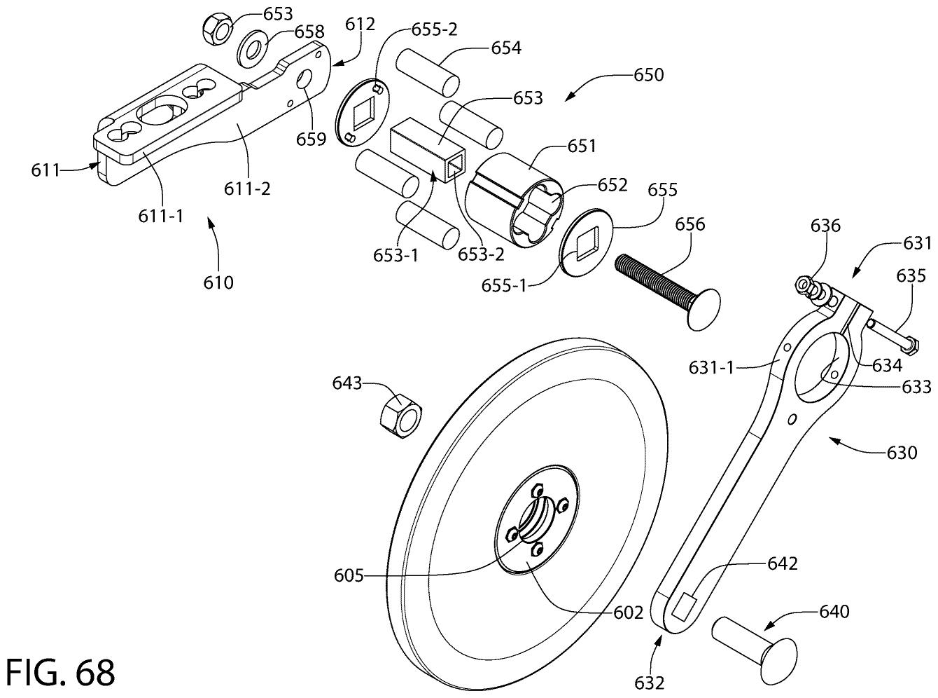

The inner core member 653 of torsion axle 650 may have a rectangular cuboid configuration with square cross-sectional shape in one embodiment as shown. This defines four flat sides 653-1 of the inner core member; each flat side being engaged by one side of one of the cord elements 654 (see, e.g., FIGS. 68-69 and 72-74). The cord elements 654 are trapped between inner core member 653 and the interior surface of outer housing 651 (e.g., arcuately concave surfaces defined by channels 652). Flats 660 may be formed between adjacent pairs of semi-circular channels 652 for cord elements 654 which abuttingly engage the flat sides 653-1 of the inner core member. This prevent relative rotation of the inner core member with respect to the outer housing 650.

To secure inner core member 653 and the cord elements 654 inside through passage of outer housing 651, a pair of end plates 655 may be provided (one for each end of the housing).

In one embodiment, the torsion axle 650 may be coupled to free-floating second end 612 of mounting bracket 610 via a threaded mounting fastener 656. In one non-limiting construction, inner core member 653 may have a tubular hollow body defining a central cavity 653-2 extending therethrough from end to end. The threaded shank of fastener 656 may inserted through the central cavity and passes through a laterally open fastener aperture 659 formed in end 612 of the mounting bracket. A threaded nut 657 and optional washer 658 may be used to secure the fastener to the torsion axle and mounting bracket.

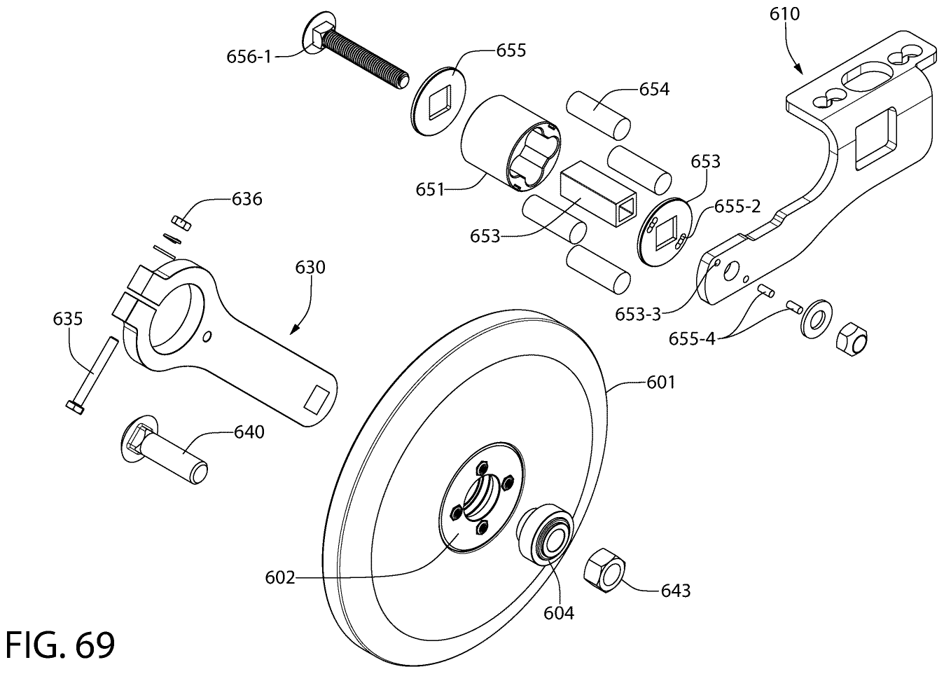

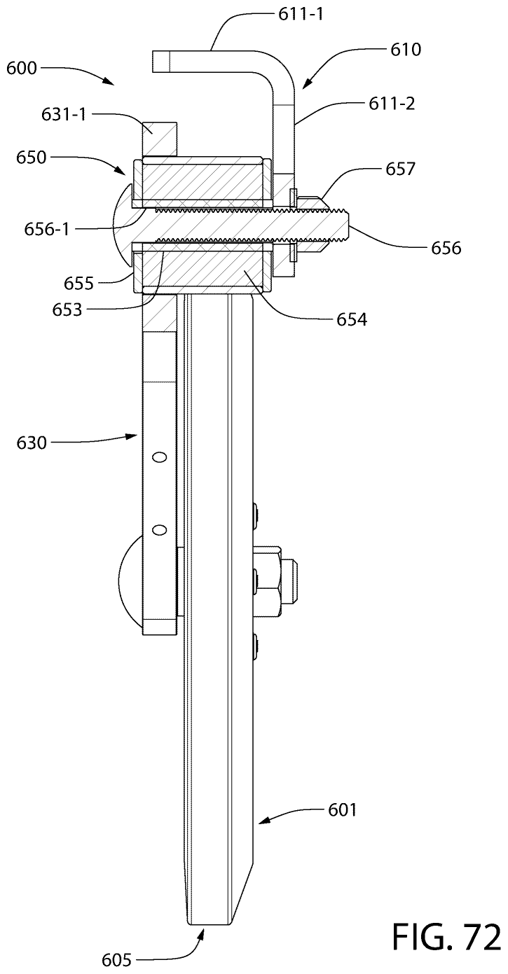

In one embodiment, the torsion axle mounting fastener 656 may be a square-shouldered carriage bolt (see, e.g., FIGS. 68-69). End plates 655 of torsion axle 650 may each include a square hole 655-1. The square hole of the end plate 655 adjacent to the bolt head receiving and engaging the square shoulder 656-1 of the bolt which prevent relative rotation therebetween. A portion of the square shoulder 656-1 of the bolt also enters cavity 653-2 of inner core member 653 to also prevent relative rotation between the inner core member and bolt (see, e.g., FIG. 72).

The opposite end plate 655 of the torsion axle adjacent to and abutting end 612 of mounting bracket 610 is rotationally locked thereto via mutual locking features. In one embodiment, the locking features includes at least one pair of circumferentially spaced apart rotational locking holes 655-2 formed in end plate 655 abutting the mounting bracket; each locking hole engaging a respective rotational locking pin 655-4 disposed on end 612. Pins 655-4 may be coupled to the mounting bracket via pin holes 655-3 in end 612 of the bracket The locking hole and pin interlock prevent relative rotation of the end plate 655 abuttingly contacting end 612 of mounting bracket 610. The opposite square ends of inner core member 653 are each inserted in a respective square hole of one of the end plates 655 (reference FIGS. 68-69). Accordingly, the mutually engaged locking holes 655-2 and pins 655-4 prevent the end plates 655 and inner core member 653 from rotating relative to mounting bracket 610 and remain stationary while the outer housing 651 of torsion axle 650 can rotate to a limited degree in response to upward/downward motion of the firming wheel 601, as further described herein. Other coupling arrangements and devices may be used in other embodiments.

In some embodiments as illustrated in FIGS. 68-69, two sets of multiple adjacent locking holes 655-2 may be provided at two circumferentially spaced apart locations. In one embodiment, three locking holes may be provided in each set. The multiple locking holes option advantageously provides three preset rotational locking positions for the inner core member 653 which applies a user-selectable preload to the torsion axle 650. For example, a first one of the three holes 655-2 (e.g., one end hole) associated with a first rotational locking position of inner core member 653 may provide a light preload. A second one of the three holes 655-2 (e.g., middle hole) associated with a second rotational locking position of inner core member 653 may provide a medium preload. And a third one of the three holes 655-2 (e.g., other end hole) associated with a third rotational locking position of inner core member 653 may provide a heavy preload to the torsion axle. This advantageously allows the user to select the appropriate preload based on the agricultural field conditions and soil type expected to be encountered when planting the seeds.

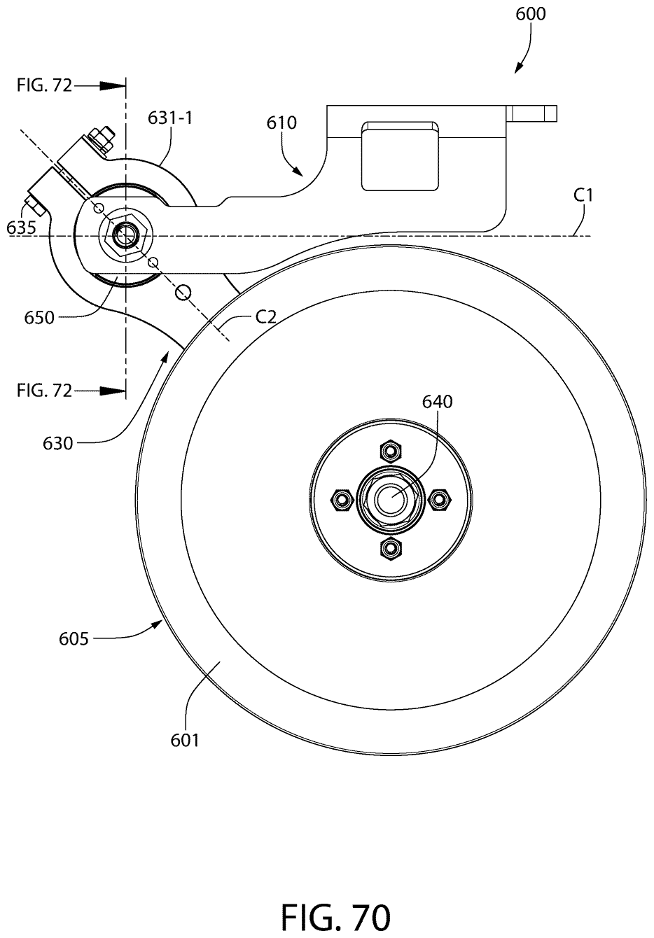

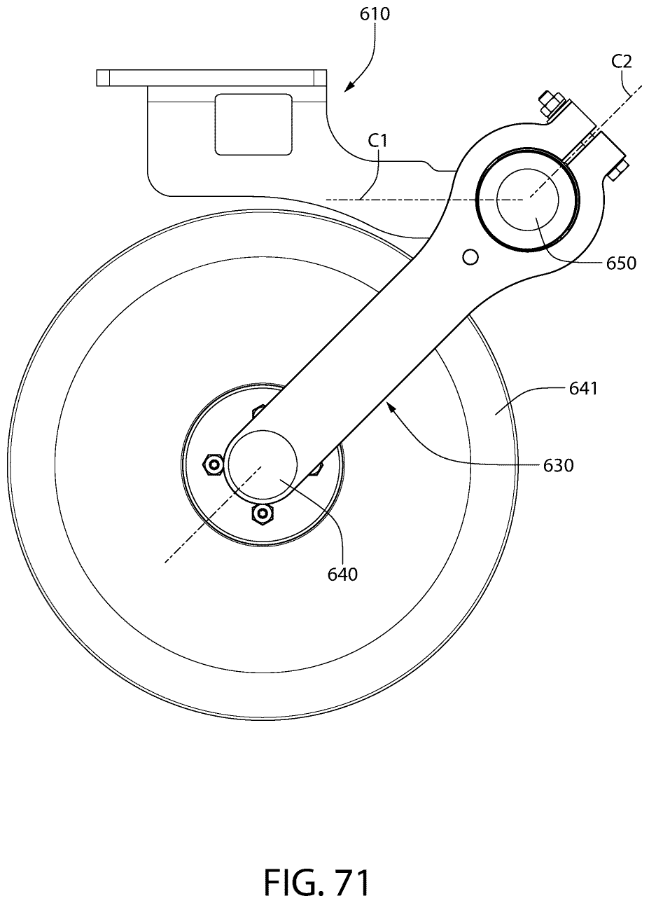

Suspension arm 630 may have any elongated body defining a centerline C2 and including an upper end 631 coupled to end 612 of mounting bracket by torsion axle 650, and a lower end 632 coupled to firming wheel 601. Centerline C2 may be disposed at an acute angle to centerline C1 of mounting bracket 610 such that the body of suspension arm 630 is angularly disposed relative to the body of the mounting bracket (see, e.g., FIGS. 70-71).

In one embodiment, upper end 631 may be fixedly coupled to the outer housing 651 of torsion axle 650. This advantageously allows the torsion axle to be coupled to the mounting bracket 610 via threaded fastener 656 (which passes through hollow inner core member 653) because any loads or forces imposed on the torsion axle through suspension arm 630 originating from firming wheel 610 are transmitted to the outer housing 651, not the inner core member of torsion axle 650.

To provide the foregoing suspension arm 630 coupling arrangement, upper end 631 of the suspension arm in one non-limiting embodiment has a bifurcated structure (e.g., split structure) which is detachably clamped around an exterior surface of the outer housing 651 of torsion axle 650 to rigidly affix the suspension arm to the torsion axle. Upper end 631 of the suspension arm defines a spreadable and collapsible central opening 633 which receives outer housing 651 of torsion axle 650 therein. The central opening is complementary configured to the cross-sectional shape of the outer housing. In one embodiment, central opening 633 and outer housing 651 of torsion axle 650 may each have a circular cross-sectional shape; however, other complementary configured mutual cross-sectional shapes such as polygonal including rectilinear may be used (e.g., hexagonal, square, etc.). The circular cross-sectional shape enables a pre-set pre-load position of the firming wheel to be infinitely configured. This allows row-by-row adjustability of the pre-load setting which would compensate for parts tolerance stack-ups.

The upper end 631 of suspension arm 630 comprises a pair of opposing jaws 631-1 movable together and apart which concomitantly shrinks or enlarges the central opening 633 to clampingly engage the torsion axle 650 (i.e. outer housing 651). A slit 634 intersects opening 633 and extends therefrom in the direction of the length of suspension arm 630 through upper end 631 along centerline C2 of the suspension arm. Slit 634 completes the bifurcated or split structure of the suspension arm upper end 631 to provide a spreadable and collapsible structure.

A tightenable locking fastener 635 extends between the pair of jaws 631-1 through slit 634 to allow the jaws to be spread apart or drawn together. Locking fastener 635 in one embodiment may be a threaded fastener which is oriented transversely to the centerline C2 and length of the suspension arm 630. The locking fastener may pass through corresponding fastener holes formed completely through each jaw and is locked in place by a threaded nut 636 in one non-limiting embodiment. In other possible embodiments, the threaded nut may be omitted by providing a blind threaded bore in one jaw and a through hole in the other jaw. Either construction may be used.

In either foregoing construction, rotating the locking fastener 635 in a first direction loosens and spreads apart the jaws 631-1 to insert outer housing 651 of torsion axle 650 therebetween in central opening 633. Conversely, rotating the locking fastener in an opposite second direction draws the jaws together for tightening against the outer housing of the torsion axle which becomes clampingly engaged by the jaws.

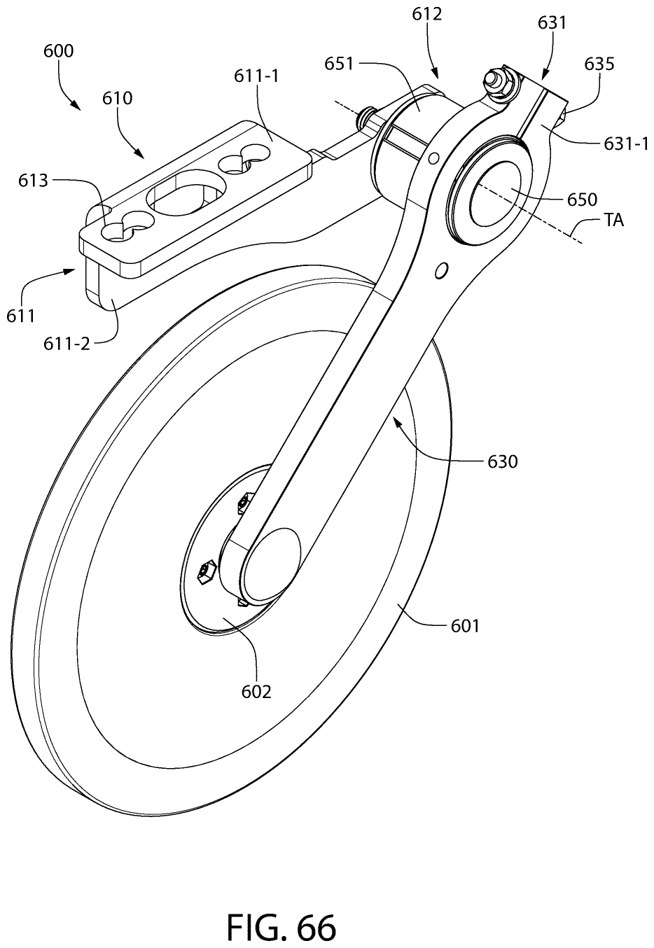

With continuing general reference to FIGS. 66-74, the firming wheel 601 is rotatably coupled to the opposite lower end 632 of suspension arm 630. In one embodiment, firming wheel 601 may be coupled to the suspension arm via a coupling fastener 640 which extends through hub 602 of the firming wheel. Threaded nut 643 attached to the threaded shank of fastener 640 on the opposite side of the hub completes coupling of the firming wheel to the suspension arm. In one embodiment, coupling fastener 640 may be a square-shouldered carriage bolt. Lower end 632 of suspension arm 630 may include a square hole which engages the square shoulder of the bolt to keep the bolt from rotating relative to the suspension arm. Other coupling arrangements and devices may be used in other embodiments.

Firming wheel 601 may have a circular body defining a circumferentially-extending and outward facing tread 605 around its perimeter which rollingly contacts the soil in planting trench 104 to press seeds dispensed by seed dispensing tube 130 into the soil. The tread cross-sectional shape is designed to match up with the shape of the trench being formed. This geometry may be reconfigured as needed depending on the specific cross-sectional geometry of the trench such that seeds are firmed into the soil to a desirable depth. The firming wheel in one embodiment may have be formed of a suitable solid elastomeric material which may be synthetic (e.g., polymer) or natural (e.g., rubber) having elastic properties and memory. Other wheel material however may be used. The firming wheel body is coupled to a centrally-located hub 602 which defines an laterally open mounting hole 606 that receives coupling fastener 640 therethrough to couple the wheel to the suspension arm 630. Firming wheel 601 further includes a bearing 604 fitted inside the hub which defines the mounting hole 606 (see, e.g., FIG. 69). Other firming wheel constructions may be used in other embodiments.

In operation of the torsion axle 650, the inner core member 653 and end plates 655 remains stationary being held tightly in position by mounting fastener 656 as previously described herein. The outer housing 651 can partially rotate to a limited degree in either direction relative to the inner core member and end plates about the torsion axis TA defined by torsion axle 650 (axis shown in FIG. 66). The degree of rotation in either direction is limited by the resiliently compressible cord elements 654 of the torsion axle which act against the interior of the outer housing 651 of the torsion axle. As previously described herein, torsion axle 650 A provides a limited degree of freedom of firming wheel 601 in the vertical direction (wheel moving up and down) and horizontal direction (side to side). As shown in FIG. 72, the upper end 631 of suspension arm 630 is fixedly clamped onto outer housing 651 of the torsion axle to transmit motion of and forces generated in suspension arm 630 by the firming wheel 601 to the outer housing, which activates the torsion axle suspension system.

In a neutral condition with no load applied to torsion axle 650, the rod-shaped cylindrical cord elements 654 remain uncompressed. When load is applied to the torsion axle as a result of the firming wheel 601 rolling along the soil in the planting trench 104 and oscillating upwards/downwards in the process, the outer housing 651 twists and rotates relative to the inner core member 653. Twisting/rotation of the torsion axle outer housing causes the cord elements 654 to become deformed and compressed in a resilient manner against the square-sided inner core member 653. This not only give the wheel 601 enough freedom of movement to maintain force and contact with the center of the trench under a variety of topographical and heading curvature conditions, but also secondarily absorbs and dampens the load or forces applied to the torsion axle. In the present application, the torsion axle 650 reduces the magnitude of those loads/forces being transmitted to the mounting bracket 610 to prevent damage to the bracket, such as cracking resulting from a large instantaneous impact force by encountering hard objects/debris in the soil or fatigue failure cracking over a period of repeated use.

A method for assembling a firming wheel assembly with resilient suspension for a planting row unit may be summarized as comprising coupling a first end 611 of the elongated mounting bracket 610 to frame 110 of the planting row unit 100. Next or before coupling the mounting bracket to row unit 100, the method may comprise coupling torsion axle 650 to a second end 612 of the mounting bracket. In either assembly scenario, the next step may be coupling an upper end 631 of the suspension arm 630 to the torsion axle 650. This may include first inserting outer housing 651 of the torsion axle through central opening 633 of the suspension arm, followed by via tightening fastener 635 to clampingly engage jaws 631-1 of the suspension arm against the outer housing. Next or before coupling the suspension arm 630 to torsion axle 650, the method may comprise coupling firming wheel to the lower end 632 of the suspension arm 630 using fastener 640.

### EXAMPLES

The following are nonlimiting examples.

Example 1—a seed delivery system comprising: a seed meter comprising a metering disc configured to hold a plurality of seeds; a seed accelerator comprising an internal passageway configured to flow an airstream therethrough, the seed accelerator including a seed capture shroud defining an inwardly open air entrainment chamber facing the metering disc and forming part of the internal passageway; and a seed dispensing tube coupled to the seed accelerator; wherein the metering disc is rotatable to move the seeds through the seed capture shroud which is configured to extract and entrain each of the seeds in the airstream.

Example 2—the seed delivery system according to Example 1, wherein the metering disc includes a circular array of seed holes each configured to retain a singulated seed.

Example 3—the seed delivery system according to Example 2, wherein the seed capture shroud covers a portion of the metering disc through which the seed holes pass through one-by-one in succession when the metering disc is rotated.

Example 4—the seed delivery system according to Example 2, wherein the seed accelerator includes an air inlet tube coupleable to a source of pressurized air and an air outlet tube coupled to the seed dispensing tube.

Example 5—the seed delivery system according to Example 4, the air inlet and outlet tubes fluidly coupled to the air entrainment chamber which is configured to convey the airstream crosswise to a circular seed path of travel on the metering disc as the metering disc rotates.

Example 6—the seed delivery system according to Example 4, wherein the seed accelerator further comprises a recurvant tube bend disposed between the air inlet and outlet tube and configured so that the airstream reverses direction in the internal passageway.

Example 7—the seed delivery system according to Example 4, wherein the air entrainment chamber is disposed in the internal passageway of the seed accelerator between the air inlet and outlet tubes.

Example 8—the seed delivery system according to Example 4, wherein the air entrainment chamber is a U-shaped structure including a top opening and a bottom opening defining a seed through passage through which seeds on the metering disc pass upon rotation thereof.

Example 9—the seed delivery system according to Example 4, wherein the seed capture shroud includes a first end wall including an air inlet port coupled to the air inlet tube, a second end wall including an air outlet port coupled to the air outlet tube, and a transverse wall extending perpendicularly between the first and second end walls.

Example 10—the seed delivery system according to Example 9, wherein the seed capture shroud has a polygonal cross-sectional shape.

Example 11—the seed delivery system according to any one of Examples 2-4, wherein the seed accelerator is configured to convey the airstream through the air entrainment chamber of the seed capture shroud from an inward to an outward and downward direction across the metering disc to extract the seeds from the seed holes.

Example 12—the seed delivery system according to any one of Examples 2-4, wherein the seed accelerator is configured to convey the airstream through the air entrainment chamber of the seed capture shroud from an outward to an inward and downward direction across the metering disc to extract the seeds from the seed holes.

Example 13—the seed delivery system according to Example 12, wherein the internal passage of the seed accelerator is configured so that the airstream flows in an arcuately curved path through the seed accelerator.

Example 14—a seed delivery system comprising: a seed meter comprising a rotatable metering disc configured to hold an array of singulated seeds; a seed accelerator comprising an accelerator wheel configured to dislodge the singulated seeds from the metering disc, and a seed chute configured to receive the seeds dislodged by the accelerator wheel; wherein the accelerator wheel is rotatable to dislodge the seeds from the metering disc in a radial outward direction and accelerate dispensing of the seed to the seed chute.

Example 15—the seed delivery system according to Example 14, wherein the accelerator wheel is rotatable about a rotational axis which is spaced inwards from a circular peripheral edge of the metering disc.

Example 16—the seed delivery system according to Examples 14 or 15, wherein the accelerator wheel rotates in the same rotational direction as the metering disc so that the acceleration imparted to the velocity of seeds by the accelerator wheel is additive to the rotational velocity of metering disc.

Example 17—the seed delivery system according to Examples 14 or 15, wherein: the seed chute comprises an arcuately curved guide wall disposed proximate to the accelerator wheel, the guide wall defining a guide surface facing inwards towards the accelerator wheel and leading into an entrance of the seed chute; and the accelerator wheel is operable to compress the seeds against the guide wall in a radial outward direction and accelerate the seeds along the guide wall into the seed chute.

Example 18—the seed delivery system according to Example 17, wherein the rotational axis of the accelerator wheel is located inside a seed path of travel on the metering disc and the guide wall is located outside the seed path of travel on the metering disc.

Example 19—the seed delivery system according to Example 17, wherein the accelerator wheel is located to dislodge seeds from the metering disc at a side position of the metering disc.

Example 20—the seed delivery system according to Example 19, wherein the side position is at approximately 3 o'clock.

Example 21—the seed delivery system according to Examples 19 or 20, the accelerator wheel is configured to dislodge the seeds from the metering disc in a tangential direction to the metering disc.

Example 22—the seed delivery system according to any one of Examples 14-16, wherein a rotational axis of accelerator wheel lies in a same horizontal reference plane as a rotational axis of the metering disc.

Example 23—the seed delivery system according to any one of Examples 14-22, wherein the accelerator wheel comprises a plurality of radial fingers configured to engage the seeds on the metering disc.

Example 24—the seed delivery system according to Example 23, wherein the fingers are arcuately curved and formed of a resilient deformable material.

Example 25—the seed delivery system according to Example 17, wherein the guide wall has an open structure which does not enclose the accelerator wheel and is disposed on an outward facing side of the accelerator wheel.

Example 26—the seed delivery system according to Example 16, wherein the seed chute is vertically oriented.

Example 27—a method for dispensing seeds for planting, comprising: forming a trench in soil with a row unit; rotating a metering disc holding an array of singulated seeds; rotating an accelerator wheel; dislodging the seeds from the metering disc in a radial outward direction with the accelerator wheel; and delivering the seeds to the trench.

Example 28—the method according to Example 27, wherein the dislodging step includes the accelerator wheel compressing the seeds against an arcuately curved guide wall disposed outboard of the accelerator wheel.

Example 29—the method according to Example 28, wherein accelerator wheel comprises a plurality of resiliently deformable radial fingers which compress the seeds against the guide wall and in return collapse inwards to store potential energy therein, and the accelerator wheel accelerates the seeds via spring-like action when the fingers return to their un-collapsed condition.

Example 30—the method according to Example 29, wherein the fingers are arcuately curved and formed of a resilient deformable material having an elastic memory.

Example 31—the method according to Example 28, wherein the rotational axis of the accelerator wheel is located inside a seed path of travel on the metering disc and the guide wall is located outside the seed path of travel on the metering disc.

Example 32—the method according to Example 28, wherein the accelerator wheel is located to dislodge seeds from the metering disc at a side position of the metering disc.

Example 33—the method according to Example 28, wherein the dislodging step comprises passing the seeds in succession to the accelerator wheel.

Example 34—the method according to any one of Examples 27-33, wherein a rotational axis of accelerator wheel lies in a same horizontal reference plane as a rotational axis of the metering disc.

Example 35—the method according to Example 34, wherein the rotational axis of the accelerator wheel lies inside a circumferential peripheral edge of the metering disc.

Example 36—the method according to Example 34, wherein the accelerator wheel and the metering disc rotate in the same direction.

Example 37—the method according to Example 28, wherein the accelerator wheel discharges the dislodged seeds into a seed chute which delivers the seeds to the trench.

Example 38—the method according to Example 37, wherein the guide wall is formed as an integral part of the seed chute.

Example 39—the method according to Example 27, wherein the seeds are disposed in a circular array of seed holes in the metering disc which rotate in succession past the accelerator wheel.

Example 40—the method according to Example 39, wherein the accelerator wheel comprises a plurality of arcuately curved fingers which intercept the seed holes at a side of the metering disc as the metering disc and accelerator wheel each rotate.

Example 41—the method according to Example 40, wherein the accelerator wheel rotates at a speed faster than the metering disc.

Example 42—an agricultural row unit comprising: a frame; a trench opening assembly configured to open a trench in a soil surface as the trench opening assembly moves in a forward direction of travel; a sub-trench opener disposed in the trench to open a sub-trench; a seed conduit configured to deposit seeds into the sub-trench; and a trench closing assembly for closing the trench and sub-trench.

Example 43—the agricultural row unit of Example 42, wherein the trench opening assembly comprises a first disc and a second disc.

Example 44—the agricultural row unit of Example 43, wherein at least one of the first disc and the second disc is notched and has a tooth between notches.

Example 46—the agricultural row unit of any one of Examples 42-44, wherein the first disc is flat.

Example 47—the agricultural row unit of any one of Examples 43 to 44, wherein the first disc is concave.

Example 48—the agricultural row unit of any one of Examples 43 to 47, wherein the tooth on the first disc is tapered.

Example 49—the agricultural row unit of any of Examples 43 to 48, wherein the second disc is flat.

Example 50—the agricultural row unit of any of Examples 43 to 48, wherein the second disc is concave.

Example 51—the agricultural row unit of any of Examples 43 to 50, wherein the tooth on the second disc is tapered.

Example 52—the agricultural row unit of any one of Examples 42 to 51 further comprising a seed meter connected to the frame and in fluid communication with the seed conduit.

Example 53—the agricultural row unit of any one of Examples 42 to 52, wherein the seed conduit is a seed orientation conduit configured to orient seeds as seeds travel along the seed orientation conduit.

Example 54—the agricultural row unit of any one of Examples 42 to 53, wherein the sub trench opener further comprises a blade extending downward from the sub trench opener.

Example 55—a method of operating an implement having a seed orientation system wherein the seed orientation system comprises: a frame; a trench opening assembly configured to open a trench in a soil surface as the trench opening assembly moves in a forward direction of travel; a seed delivery system for delivering seed to the trench; a gas source for providing gas to the seed orientation system to propel seed through the seed orientation system; and a trench closing assembly for closing the trench, the method comprising: determining a speed of the implement; and setting an gas pressure for the gas source based on the determined speed.

Example 56—the method of Example 1, wherein as speed increases gas pressure increases, and as speed decreases gas pressure decreases.

Example 57—the method of Example 1 or Example 2, wherein as speed changes, gas pressure continuously changes with speed.

Example 58—the method of Example 1 or Example 2, wherein speed is divided into a plurality of subranges, and there is one gas pressure for each subrange.

Example 59—the method of any preceding Example, wherein the gas is air.

Example 60—the method of any one of Examples 55 to 59, wherein the seed delivery system is a seed orientation delivery system.

Example 61—the method of any one of Examples 55 to 60, wherein the seed orientation further comprises a seed meter for providing singulated seed to the seed delivery system.

The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures, but is to be accorded the widest scope consistent with the spirit and scope of the appended claims.

1. A seed firming wheel assembly with resilient suspension for a planting row unit, the seed firming wheel assembly comprising:
an elongated mounting bracket comprising a first end configured to be coupled to a frame of the row unit and a second end;
a torsion axle coupled to the second end;
an elongated suspension arm having an upper end detachably coupled to the torsion axle and a lower end;
a firming wheel rotatably coupled to the lower end of the suspension arm;
the firming wheel being supported in a cantilevered manner from the torsion axle by the suspension arm;
wherein the firming wheel is operable to press seeds into soil within a planting trench.

2. The seed firming wheel assembly according to claim 1, wherein the torsion axle comprises an outer housing, a centrally-located inner core member, and a plurality of resiliently compressible cord elements spaced circumferentially apart around the inner core member inside the outer housing.

3. The seed firming wheel assembly according to claim 1, wherein the inner core member comprises a tubular hollow body defining a central extending therethrough from end to end, and further comprising a mounting fastener inserted through the central cavity which couples the torsion axle to the second end of the mounting bracket.

4. The seed firming wheel assembly according to claim 3, wherein the upper end of the suspension arm has a bifurcated structure which is detachably clamped around an exterior surface of the outer housing of the torsion axle to rigidly affix the suspension arm to the torsion axle.

5. The seed firming wheel assembly according to claim 4, wherein upper end of the suspension arm defines a spreadable and collapsible central opening which receives the outer housing of the torsion axle therein, the central opening being complementary configured to a cross-sectional shape of the outer housing.

6. The seed firming wheel assembly according to claim 5, wherein the central opening of the suspension arm and the outer housing of the torsion axle each have a circular cross-sectional shape.

7. The seed firming wheel assembly according to claim 5, wherein the upper end of the suspension arm comprises a pair of opposing jaws movable together and apart, the jaws defining the central opening, and a tightenable locking fastener extending between the jaws.

8. The seed firming wheel assembly according to claim 7, wherein rotating the locking fastener in a first direction loosens the jaws, and rotating the locking fastener in an opposite second direction tightens the jaws against the outer housing of the torsion axle.

9. The seed firming wheel assembly according to claim 7, wherein the locking fastener is a threaded fastener which is oriented transversely to a length of the suspension arm, the locking fastener extending through corresponding holes in the jaws.

10. The seed firming wheel assembly according to any claim 2, wherein the inner core member of the torsion axle has a rectangular cuboid configuration and the outer housing has a cylindrical configuration defining a central passage which holds the inner core member and cord elements.

11. The seed firming wheel assembly according to claim 10, wherein the cord elements are cylindrical and the outer housing defines a plurality of semi-circular channels which partially receive and hold the cord elements in circumferentially spaced apart relationship.

12. The seed firming wheel assembly according to any claim 3 wherein the mounting fastener holds the inner core member in a stationary position, the outer housing being partially rotatable to a degree in opposing directions about the inner core member which in turn compresses the cord elements to dampen upward and downward motion of the firming wheel.

13. The seed firming wheel assembly according to any claim 1, wherein at least a portion of the firming wheel is disposed directly below the first end of the mounting bracket.

14. The seed firming wheel assembly according to any claim 1, wherein the second end of the mounting bracket is free-floating being unattached to the row unit frame such that the torsion axle is supported in a cantilevered manner by the mounting bracket from the row unit frame.

15. The seed firming wheel assembly according to any claim 1, wherein the seed firming wheel comprises a solid disc formed of a resiliently deformable elastomeric material.

16. The seed firming wheel assembly according to any claim 2, wherein upward or downward movement of the firming wheel in the planting trench resiliently compresses the cord elements between the inner core member and outer housing to dampen forces transmitted to the mounting bracket from the firming wheel via the suspension arm.

17. The seed firming wheel assembly according to claim 1, wherein the first end of the mounting bracket has an L-shaped configuration comprising a horizontal coupling portion defining at least one pair of fastener holes which receive threaded mounting fasteners for coupling to the support frame of the planting row unit and an adjoining vertical section.

18. The seed firming wheel assembly according to claim 1, wherein the lower end of the suspension arm is coupled to a hub of the firming wheel via a square-shouldered carriage bolt.

19. The seed firming wheel assembly according to claim 1, wherein a centerline of the suspension arm is disposed at an acute angle to a centerline of the mounting bracket, the torsion axle defining an elbow joint connecting the suspension arm and the mounting bracket.

20. The seed firming wheel assembly according to any claim 2, wherein the torsion axle comprises an end plate rotationally locked to the second end of the mounting bracket, the end plate comprising two sets of multiple locking holes, at least one locking hole in each set insertably receiving a locking pin fixedly coupled to the second end of the mounting bracket, the locking holes providing a user-adjustable preload of the torsion axle on the firming wheel depending on which locking holes are selected in each set to receive the locking pins.

21. A planting row unit comprising the seed firming wheel assembly according to claim 1, wherein the planting row unit comprises a pair of opening discs configured to form the planting trench in the soil, a pair of gauge wheel configured to regulate a depth of the planting trench, and a pair of closing wheels configured to close the trench, the firmer wheel being disposed between the opening discs and rearward of a sub-trench opener.

22. A method for assembling a firming wheel assembly with resilient suspension for a planting row unit, the method comprising:
coupling a first end of an elongated mounting bracket to a frame of the planting row unit;
coupling a torsion axle to a second end of the planting row unit;
coupling an upper end of the suspension arm to the torsion axle; and
coupling a rotatable firming wheel to a lower end of the suspension arm.
